(19) United States
(12) Patent Application Publication
(10) Pub. No.: US 2024/0119087 A1
(43) Pub. Date: Apr. 11, 2024

(54) IMAGE PROCESSING APPARATUS, IMAGE PROCESSING METHOD, AND NON-TRANSITORY STORAGE MEDIUM

(71) Applicant: NEC Corporation, Minato-ku, Tokyo (JP)

(72) Inventor: Noboru YOSHIDA, Tokyo (JP)

(73) Assignee: NEC Corpration, Minato-ku, Tokyo (JP)

(21) Appl. No.: 18/275,693

(22) PCT Filed: May 25, 2021
(86) PCT No.: PCT/JP2021/019795

§ 371 Date: Aug. 3, 2023

(51) Int. Cl. G06F 16/583; G06T 7/20; G06V 10/44

(52) U.S. Cl. CPC G06F 16/583; G06T 7/20; G06V 10/44; G06T 2207/20044

(57) ABSTRACT

The present invention provides an image processing apparatus (100) including: a query acquisition unit (109) that acquires a plurality of first frame images in time series; a skeletal structure detection unit (102) that detects a keypoint of an object included in each of a plurality of the first frame images; a feature value computation unit (103) that computes a feature value of the detected keypoint for each of the first frame images; a change computation unit (110) that computes a direction of change in the feature value along a time axis of a plurality of the first frame images in time series; and a search unit (111) that searches for a moving image by using the computed direction of change in the feature value as a key.

### TECHNICAL FIELD

The present invention relates to an image processing apparatus, an image processing method, and a program.

### BACKGROUND ART

In recent years, in a surveillance system or the like, a technique of detecting or searching for a state such as a pose or an action of a person from an image by a surveillance camera has been utilized. As a related technique, for example, Patent Documents 1 and 2 are known. Patent Document 1 discloses a technique of searching for a pose of a similar person, based on a key joint such as a head or a limb of a person included in a depth video. Patent Document 2 discloses a technique of searching for a similar image by utilizing pose information such as an inclination added to the image, although not being related to the pose of the person. In addition, as a technique related to skeletal estimation of a person, Non-Patent Document 1 is known.

On the other hand, in recent years, it has been studied to utilize a moving image as a query and search for a moving image similar to the query. For example, Patent Document 3 describes that, when a reference video serving as a query is input, a similar video is searched for by using the number of faces of characters, and positions, sizes, and orientations of the faces of the characters.

### RELATED DOCUMENT

### Patent Document

Patent Document 1: Published Japanese Translation of PCT International Publication for Patent Application, No. 2014-522035 Patent Document 2: Japanese Patent Application Publication No. 2006-260405
Patent Document 3: International Patent Publication No. WO 2006/025272

### Non Patent Document

Non-Patent Document 1: Zhe Cao, Tomas Simon, Shih-En Wei, Yaser Sheikh, “Realtime Multi-Person 2D Pose Estimation using Part Affinity Fields”, The IEEE Conference on Computer Vision and Pattern Recognition (CVPR), 2017, PP. 7291 to 7299

### DISCLOSURE OF THE INVENTION

### Technical Problem

It is difficult to improve search accuracy of processing of searching for a moving image including a desired scene. One object of the present invention is to improve the search accuracy of processing of searching for a moving image including a desired scene.

### Solution to Problem

According to the present invention, there is provided an image processing apparatus including: a query acquisition unit that acquires a plurality of first frame images in time series; a skeletal structure detection unit that detects a keypoint of an object included in each of a plurality of the first frame images; a feature value computation unit that computes a feature value of the detected keypoint for each of the first frame images; a change computation unit that computes a direction of change in the feature value along a time axis of a plurality of the first frame images in time series; and a search unit that searches for a moving image by using the computed direction of change in the feature value as a key.

Further, according to the present invention, there is provided an image processing method causing a computer to execute: a query acquisition step of acquiring a plurality of first frame images in time series; a skeletal structure detection step of detecting a keypoint of an object included in each of a plurality of the first frame images; a feature value computation step of computing a feature value of the detected keypoint for each of the first frame images; a change computation step of computing a direction of change in the feature value along a time axis of a plurality of the first frame images in time series; and a search step of searching for a moving image by using the computed direction of change in the feature value as a key.

Further, according to the present invention, there is provided a program causing a computer to function as: a query acquisition unit that acquires a plurality of first frame images in time series; a skeletal structure detection unit that detects a keypoint of an object included in each of a plurality of the first frame images; a feature value computation unit that computes a feature value of the detected keypoint for each of the first frame images; a change computation unit that computes a direction of change in the feature value along a time axis of a plurality of the first frame images in time series; and a search unit that searches for a moving image by using the computed direction of change in the feature value as a key.

### Advantageous Effects of Invention

According to the present invention, it is possible to improve search accuracy of processing of searching for a moving image including a desired scene.

### BRIEF DESCRIPTION OF THE DRAWINGS

The foregoing object and other objects, features, and advantages will become more apparent from the following description of public example embodiments and the following accompanying drawings thereto.

FIG. 1 It is a configuration diagram illustrating an outline of an image processing apparatus according to an example embodiment.

FIG. 2 It is a configuration diagram illustrating a configuration of an image processing apparatus according to a first example embodiment.

FIG. 3 It is a flowchart illustrating an image processing method according to the first example embodiment.

FIG. 4 It is a flowchart illustrating a classification method according to the first example embodiment.

FIG. 5 It is a flowchart illustrating a search method according to the first example embodiment.

FIG. 6 It is a diagram illustrating an example of detection of a skeletal structure according to the first example embodiment.

FIG. 7 It is a diagram illustrating a human body model according to the first example embodiment.

FIG. 8 It is a diagram illustrating an example of detection of a skeletal structure according to the first example embodiment.

FIG. 9 It is a diagram illustrating an example of detection of a skeletal structure according to the first example embodiment.

FIG. 10 It is a diagram illustrating an example of detection of a skeletal structure according to the first example embodiment.

FIG. 11 It is a graph illustrating a specific example of a classification method according to the first example embodiment.

FIG. 12 It is a diagram illustrating an example of display of a classification result according to the first example embodiment.

FIG. 13 It is a diagram for explaining a search method according to the first example embodiment.

FIG. 14 It is a diagram for explaining a search method according to the first example embodiment.

FIG. 15 It is a diagram for explaining a search method according to the first example embodiment.

FIG. 16 It is a diagram for explaining a search method according to the first example embodiment.

FIG. 17 It is a diagram illustrating an example of display of a search result according to the first example embodiment.

FIG. 18 It is a configuration diagram illustrating a configuration of an image processing apparatus according to a second example embodiment.

FIG. 19 It is a flowchart illustrating an image processing method according to the second example embodiment.

FIG. 20 It is a flowchart illustrating a specific example 1 of a method of computing the number of height pixels according to the second example embodiment.

FIG. 21 It is a flowchart illustrating a specific example 2 of the method of computing the number of height pixels according to the second example embodiment.

FIG. 22 It is a flowchart illustrating a specific example 2 of the method of computing the number of height pixels according to the second example embodiment.

FIG. 23 It is a flowchart illustrating a normalization method according to the second example embodiment.

FIG. 24 It is a diagram illustrating a human body model according to the second example embodiment.

FIG. 25 It is a diagram illustrating an example of detection of a skeletal structure according to the second example embodiment.

FIG. 26 It is a diagram illustrating an example of detection of a skeletal structure according to the second example embodiment.

FIG. 27 It is a diagram illustrating an example of detection of a skeletal structure according to the second example embodiment.

FIG. 28 It is a diagram illustrating a human body model according to the second example embodiment.

FIG. 29 It is a diagram illustrating an example of detection of a skeletal structure according to the second example embodiment.

FIG. 30 It is a histogram for explaining the method of computing the number of height pixels according to the second example embodiment.

FIG. 31 It is a diagram illustrating an example of detection of a skeleton structure according to the second example embodiment.

FIG. 32 It is a diagram illustrating a three-dimensional human body model according to the second example embodiment.

FIG. 33 It is a diagram for explaining a method of computing the number of height pixels according to the second example embodiment.

FIG. 34 It is a diagram for explaining the method of computing the number of height pixels according to the second example embodiment.

FIG. 35 It is a diagram for explaining the method of computing the number of height pixels according to the second example embodiment.

FIG. 36 It is a diagram for explaining a normalization method according to the second example embodiment.

FIG. 37 It is a diagram for explaining the normalization method according to the second example embodiment.

FIG. 38 It is a diagram for explaining the normalization method according to the second example embodiment.

FIG. 39 It is a diagram illustrating an example of a hardware configuration of an image processing apparatus.

FIG. 40 It is a configuration diagram illustrating a configuration of an image processing apparatus according to a third example embodiment.

FIG. 41 It is a diagram for explaining query frame selection processing according to the third example embodiment.

FIG. 42 It is a diagram for explaining query frame selection processing according to the third example embodiment.

FIG. 43 It is a diagram for explaining processing of computing a direction of change of a feature value according to the third example embodiment.

FIG. 44 It is a flowchart illustrating an example of a flow of processing performed by the image processing apparatus according to the third example embodiment.

FIG. 45 It is a configuration diagram illustrating a configuration of the image processing apparatus according to the third example embodiment.

FIG. 46 It is a flowchart illustrating an example of a flow of processing performed by the image processing apparatus according to the third example embodiment.

### DESCRIPTION OF EMBODIMENTS

Hereinafter, example embodiments of the present invention will be explained with reference to the drawings. In all the drawings, the same components are denoted by the same reference numerals, and explanation thereof will be omitted as appropriate.

### (Examination Leading to Example Embodiments)

In recent years, image recognition technique utilizing machine learning such as deep learning has been applied to various systems. For example, the present invention is applied to a surveillance system that performs surveillance by an image of a surveillance camera. By utilizing machine learning in a surveillance system, it is becoming possible to recognize a state such as a pose and an action of a person from an image to some extent.

However, in such a related technique, a state of a person desired by a user on demand, may not necessarily be recognized. For example, in some cases, a state of a person to be desirably searched and recognized by a user can be determined in advance, and in other cases, a state that is unknown cannot be specifically determined. Then, in some cases, it is not possible to specify the state of the person the user desires to search in detail. In addition, in a case where a part of a body of a person is hidden, a search or the like cannot be performed. In the related art, since the state of a person can be searched only from a specific search condition, it is difficult to flexibly search or classify the state of a desired person.

Therefore, the inventors have studied a method using a skeletal estimation technique such as Non-Patent Document 1 in order to recognize a state of a person desired by a user from an image on demand. In a related skeletal estimation technique such as OpenPose disclosed in Non-Patent Document 1, a skeleton of a person is estimated by learning image data with correct answers of various patterns. In the following example embodiments, it is possible to flexibly recognize the state of a person by utilizing such a skeletal estimation technique.

The skeletal structure estimated by a skeletal estimation technique such as OpenPose is composed of “keypoints” which are characteristic points of joints and the like, and “bones (bone links)” which indicate links between keypoints. Therefore, in the following example embodiments, the skeletal structure will be explained by using the terms “keypoint” and “bone”, but unless otherwise limited, “keypoint” is associated to a “joint” of a person and “bone” is associated to a “bone” of a person.

### Summary of Example Embodiment

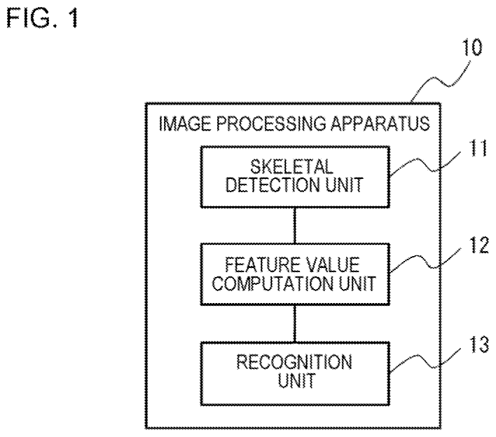

FIG. 1 illustrates an outline of an image processing apparatus 10 according to an example embodiment. As illustrated in FIG. 1, the image processing apparatus 10 includes a skeletal detection unit 11, a feature value computation unit 12, and a recognition unit 13. The skeletal detection unit 11 detects a two-dimensional skeletal structure of a plurality of persons, based on a two-dimensional image acquired from a camera or the like. The feature value computation unit 12 computes feature values of a plurality of two-dimensional skeletal structures detected by the skeletal detection unit 11. The recognition unit 13 performs recognition processing of states of a plurality of persons, based on similarity of the plurality of feature values computed by the feature value computation unit 12. The recognition processing is classification processing, search processing, or the like of a state of a person.

As described above, in the example embodiment, by detecting the two-dimensional skeletal structure of the person from the two-dimensional image and performing recognition processing such as classification and search of the state of the person, based on the feature value computed from the two-dimensional skeletal structure, it is possible to flexibly recognize the state of the desired person.

### First Example Embodiment

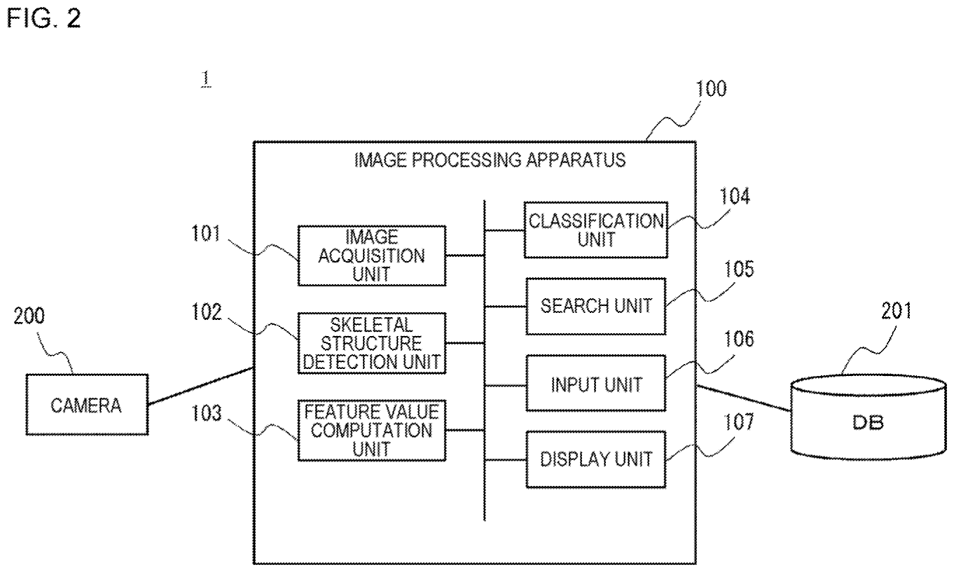

Hereinafter, a first example embodiment will be explained with reference to the drawings. FIG. 2 illustrates a configuration of the image processing apparatus 100 according to the present example embodiment. The image processing apparatus 100 constitutes an image processing system 1 together with a camera 200 and a database (DB) 201. The image processing system 1 including the image processing apparatus 100 is a system that classifies and searches for a state such as a pose and an action of a person, based on a skeletal structure of a person estimated from an image.

The camera 200 is an imaging unit such as a surveillance camera that generates a two-dimensional image. The camera 200 is installed at a predetermined location and captures an image of a person or the like in an imaging region from an installation location. The camera 200 is directly connected to the image processing apparatus 100 in such a way that a captured image (video) can be output, or is connected via a network or the like. The camera 200 may be provided inside the image processing apparatus 100.

The database 201 is a database that stores information (data) necessary for processing performed by the image processing apparatus 100, processing results, and the like. The database 201 stores an image acquired by an image acquisition unit 101, a detection result of a skeletal structure detection unit 102, data for machine learning, a feature value computed by a feature value computation unit 103, a classification result of a classification unit 104, a search result of a search unit 105, and the like. The database 201 is directly connected to the image processing apparatus 100 in such a way that data can be input and output as necessary, or is connected via a network or the like. The database 201 may be provided inside the image processing apparatus 100 as a non-volatile memory such as a flash memory, a hard disk apparatus, or the like.

As illustrated in FIG. 2, the image processing apparatus 100 includes the image acquisition unit 101, the skeletal structure detection unit 102, the feature value computation unit 103, the classification unit 104, the search unit 105, an input unit 106, and a display unit 107. Note that a configuration of each unit (block) is an example, and other units may be configured as long as a method (an operation) to be described later is possible. Further, the image processing apparatus 100 is achieved by, for example, a computer apparatus such as a personal computer or a server that executes a program, but may be achieved by one apparatus or may be achieved by a plurality of apparatuses on a network. For example, the input unit 106, the display unit 107, or the like may be an external apparatus. In addition, both the classification unit 104 and the search unit 105 may be provided, or only one of them may be provided. Both or one of the classification unit 104 and the search unit 105 is a recognition unit that performs recognition processing of a state of a person.

The image acquisition unit 101 acquires a two-dimensional image including a person captured by the camera 200. For example, the image acquisition unit 101 acquires an image including a person (a video including a plurality of images), which is captured by the camera 200 during a predetermined surveillance period. Note that not only acquisition from the camera 200 but also an image including a person prepared in advance may be acquired from the database 201 or the like.

The skeletal structure detection unit 102 detects a two-dimensional skeletal structure of a person in the image, based on the acquired two-dimensional image. The skeletal structure detection unit 102 detects a skeletal structure for all persons recognized in the acquired image. The skeletal structure detection unit 102 detects a skeletal structure of a person, based on a feature such as a joint of the recognized person by using a skeletal estimation technique using machine learning. The skeletal structure detection unit 102 uses, for example, a skeletal estimation technique such as OpenPose of Non-Patent Document 1.

The feature value computation unit 103 computes a feature value of the detected two-dimensional skeletal structure, and stores the computed feature value in the database 201 in association with the image to be processed. The feature value of the skeletal structure indicates a feature of a skeleton of a person, and serves as an element for classifying and searching a state of the person, based on the skeleton of the person. Normally, this feature value includes a plurality of parameters (for example, a classification element to be described later). The feature value may be a feature value of the entire skeletal structure, a feature value of a part of the skeletal structure, or may include a plurality of feature values as in each part of the skeletal structure. A method of computing a feature value may be any method such as machine learning or normalization, and a minimum value or a maximum value may be acquired as normalization. As an example, the feature value is a feature value acquired by performing machine learning on the skeletal structure, a size on an image from a head to a foot of the skeletal structure, or the like. The size of the skeletal structure is a height, an area, or the like of a skeletal region including the skeletal structure on the image in an up-down direction. The up-down direction (height direction or longitudinal direction) is an up-down direction (Y-axis direction) in the image, and is, for example, a direction perpendicular to a ground (reference surface). A horizontal direction (lateral direction) is a left-right direction (X-axis direction) in the image, and is, for example, a direction parallel to the ground.

In order to perform a classification or a search to be desired by a user, it is desirable to use a feature value having robustness to the classification or the search processing. For example, when the user desires a classification or search that does not depend on an orientation or a body shape of the person, a feature value that is robust to the orientation or body shape of the person may be used. By learning a skeleton of a person facing in various directions in the same pose or skeletons of persons of various body shapes in the same pose, or extracting a feature of only the up-down direction of the skeleton, it is possible to acquire a feature value independent of the orientation or the body shape of the person.

The classification unit 104 classifies (clusters) the plurality of skeletal structures stored in the database 201, based on the similarity of the feature values of the skeletal structures. It can be also said that the classification unit 104 classifies states of a plurality of persons, based on the feature values of the skeletal structure as the recognition processing of the states of the persons. The similarity is a distance between feature values of the skeletal structures. The classification unit 104 may be classified according to the similarity of the feature values of the entire skeletal structure, may be classified according to the similarity of the feature values of a part of the skeletal structure, or may be classified according to the similarity of the feature values of a first portion (for example, both hands) and a second portion (for example, both feet) of the skeletal structure. Note that the pose of the person may be classified based on the feature value of the skeletal structure of the person in each image, or the action of the person may be classified based on the change in the feature value of a skeletal structure of a person in a plurality of images consecutive in time series. Namely, the classification unit 104 can classify the state of the person including the pose and the action of the person, based on the feature value of the skeletal structure. For example, the classification unit 104 sets, as a classification target, a plurality of skeletal structures in a plurality of images captured in a predetermined surveillance period. The classification unit 104 acquires the similarity between the feature values to be classified, and classifies the skeletal structures having high similarity into the same cluster (a group having a similar pose). As in the search, a classification condition may be specified by a user. The classification unit 104 stores a classification result of the skeletal structure in the database 201 and displays the classification result on the display unit 107.

The search unit 105 searches for a skeletal structure having a high degree of similarity with a feature value of a search query (query state) from among a plurality of skeletal structures stored in the database 201. It can be also said that the search unit 105 searches for a state of a person falling under a search condition (query state) from among states of a plurality of persons, based on a feature value of the skeletal structure as recognition processing of a state of the person. Similar to the classification, the similarity is a distance between the feature values of the skeletal structure. The search unit 105 may search by the similarity of the feature values of the entire skeletal structure, may search by the similarity of the feature values of a part of the skeletal structure, or may search by the similarity of the feature values of the first portion (for example, both hands) and the second portion (for example, both feet) of the skeletal structure. Note that the pose of the person may be searched based on the feature value of the skeletal structure of the person in each image, or the action of the person may be searched based on the change in the feature value of the skeletal structure of the person in a plurality of images consecutive in time series. Namely, the search unit 105 can search for the state of the person including the pose and the action of the person, based on the feature value of the skeletal structure. For example, similarly to the classification target, the search unit 105 sets, as search targets, feature values of a plurality of skeletal structures in a plurality of images captured in a predetermined surveillance period. Further, a skeletal structure (pose) specified by a user from among the classification results displayed by the classification unit 104 is set as a search query (search key). Note that not only the classification result but also a search query may be selected from among a plurality of non-classified skeletal structures, or a skeletal structure to be a search query may be input by the user. The search unit 105 searches for a feature value having a high degree of similarity with the feature value of the skeletal structure of the search query from among the feature values of the search target. The search unit 105 stores the search result of the feature value in the database 201 and displays the search result on the display unit 107.

The input unit 106 is an input interface for acquiring information being input from a user operating the image processing apparatus 100. For example, the user is a surveillance person who performs surveillance on a person in a suspicious state from an image of the surveillance camera. The input unit 106 is, for example, a Graphical User Interface (GUI), and information in response to an operation by the user is input from an input apparatus such as a keyboard, a mouse, or a touch panel. For example, the input unit 106 receives, as a search query, a skeletal structure of a specified person from among the skeletal structures (poses) classified by the classification unit 104.

The display unit 107 is a display unit that displays a result and the like of an operation (processing) of the image processing apparatus 100, and is, for example, a display apparatus such as a liquid crystal display or an organic Electro Luminescence (EL) display. The display unit 107 displays the classification result of the classification unit 104 and the search result of the search unit 105 in a GUI according to the similarity or the like.

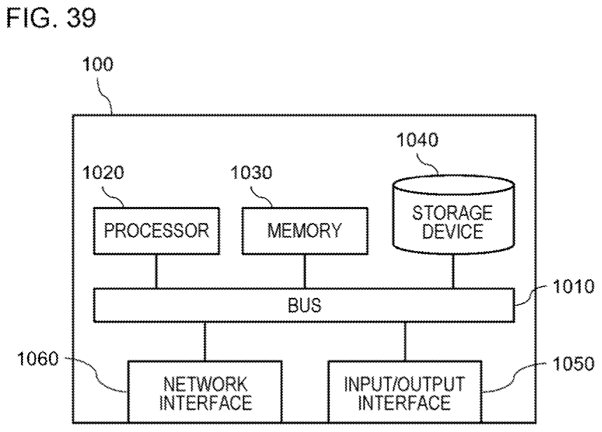

FIG. 39 is a diagram illustrating an example of a hardware configuration of the image processing apparatus 100. The image processing apparatus 100 includes a bus 1010, a processor 1020, a memory 1030, a storage device 1040, an input/output interface 1050, and a network interface 1060.

The bus 1010 is a data transmission path through which the processor 1020, the memory 1030, the storage device 1040, the input/output interface 1050, and the network interface 1060 transmit and receive data to and from each other. However, a method of connecting the processor 1020 and the like to each other is not limited to a bus connection.

The processor 1020 is a processor achieved by a Central Processing Unit (CPU), a Graphics Processing Unit (GPU), or the like.

The memory 1030 is a main storage apparatus achieved by a Random Access Memory (RAM) or the like.

The storage device 1040 is an auxiliary storage apparatus achieved by a Hard Disk Drive (HDD), a Solid State Drive (SSD), a memory card, a Read Only Memory (ROM), or the like. The storage device 1040 stores a program module that achieves each function of the image processing apparatus 100 (for example, the image acquisition unit 101, the skeletal structure detection unit 102, the feature value computation unit 103, the classification unit 104, the search unit 105, and the input unit 106). When the processor 1020 reads and executes the program modules on the memory 1030, the functions associated to the program modules are achieved. The storage device 1040 may also function as the database 201.

The input/output interface 1050 is an interface for connecting the image processing apparatus 100 and various input/output apparatuses. When the database 201 is located outside the image processing apparatus 100, the image processing apparatus 100 may be connected to the database 201 via the input/output interface 1050.

The network interface 1060 is an interface for connecting the image processing apparatus 100 to a network. The network is, for example, a Local Area Network (LAN) or a Wide Area Network (WAN). A method by which the network interface 1060 connects to the network may be a wireless connection or a wired connection. The image processing apparatus 100 may communicate with the camera 200 via the network interface 1060. When the database 201 is located outside the image processing apparatus 100, the image processing apparatus 100 may be connected to the database 201 via the network interface 1060.

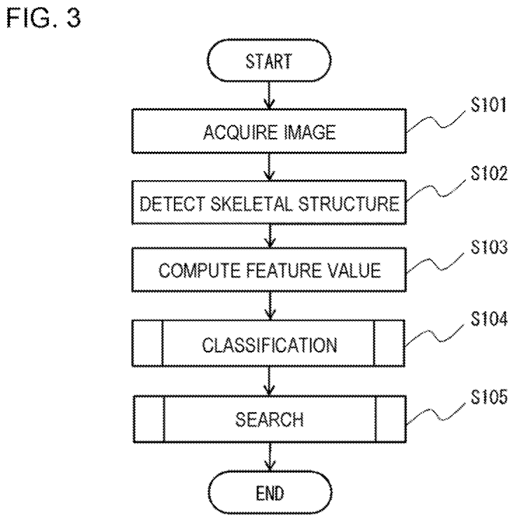

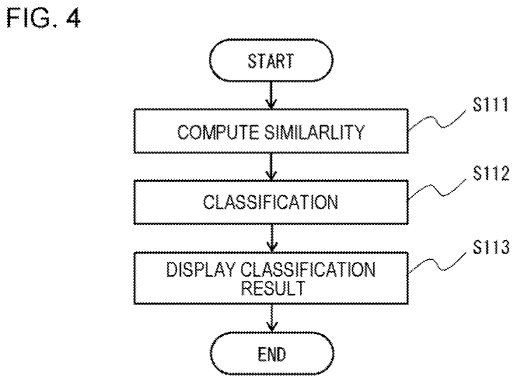

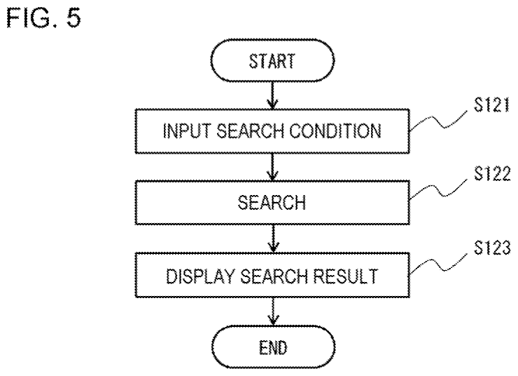

FIGS. 3 to 5 illustrate an operation of the image processing apparatus 100 according to the present example embodiment. FIG. 3 illustrates a flow from image acquisition to search processing in the image processing apparatus 100, FIG. 4 illustrates a flow of classification processing (S104) in FIG. 3, and FIG. 5 illustrates a flow of search processing (S105) in FIG. 3.

As illustrated in FIG. 3, the image processing apparatus 100 acquires an image from the camera 200 (S101). The image acquisition unit 101 acquires an image acquired by capturing a person in order to perform classification and search from a skeletal structure, and stores the acquired image in the database 201. For example, the image acquisition unit 101 acquires a plurality of images captured in a predetermined surveillance period, and performs subsequent processing on all persons included in the plurality of images.

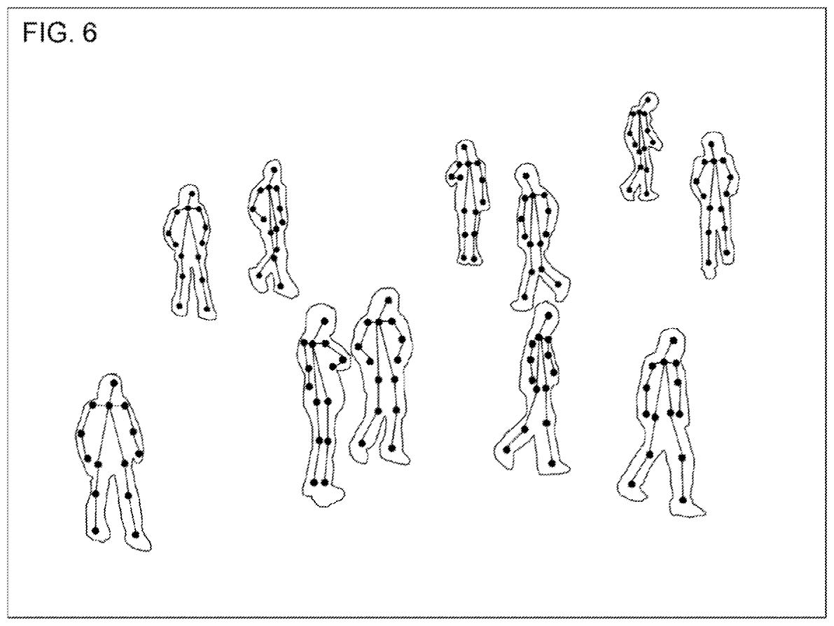

Subsequently, the image processing apparatus 100 detects the skeletal structure of the person, based on the acquired image of the person (S102). FIG. 6 illustrates an example of detection of a skeletal structure. As illustrated in FIG. 6, an image acquired from a surveillance camera or the like includes a plurality of persons, and a skeletal structure is detected for each person included in the image.

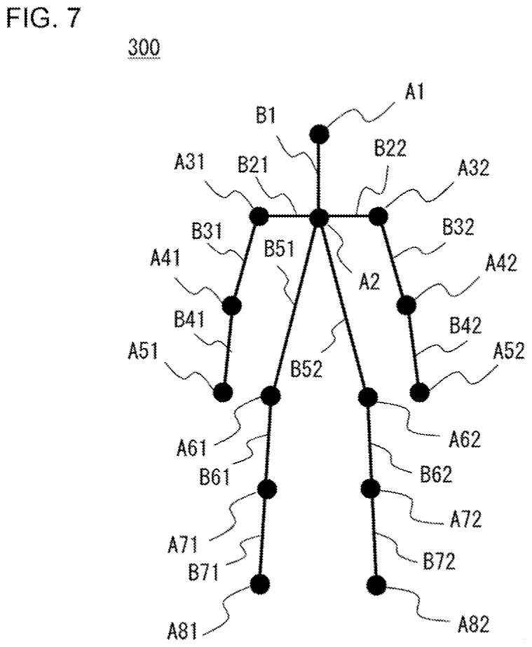

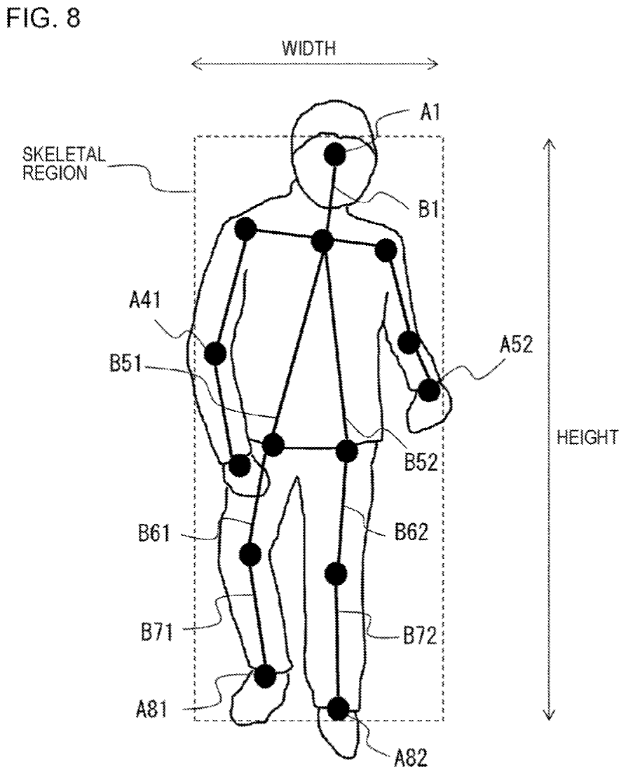

FIG. 7 illustrates a skeletal structure of a human body model 300 to be detected at this time, and FIGS. 8 to 10 illustrate an example of detection of the skeletal structure. The skeletal structure detection unit 102 detects the skeletal structure of the human body model (two-dimensional skeletal model) 300 as illustrated in FIG. 7 from a two-dimensional image by using a skeletal estimation technique such as OpenPose. The human body model 300 is a two-dimensional model composed of a keypoint such as a joint of a person and a bone connecting the keypoints.

For example, the skeletal structure detection unit 102 extracts feature points that may be keypoints from the image, and detects each keypoint of the person with reference to information acquired by machine learning the image of the keypoints. In the example of FIG. 7, a head A1, a neck A2, a right shoulder A31, a left shoulder A32, a right elbow A41, a left elbow A42, a right hand A51, a left hand A52, a right waist A61, a left waist A62, a right knee A71, a left knee A72, a right foot A81, and a left foot A82 are detected as keypoints of a person. Further as a bone of the person, which connects these keypoints, there are detected a bone B1 that connects the head A1 and the neck A2, a bone B21 that connects the neck A2 and the right shoulder A31 and a bone B22 that connects the neck A2 and the left shoulder A32, a bone B31 that connects the right shoulder A31 and the right elbow A41 and a bone B32 that connects the left shoulder A32 and the left elbow A42, a bone B41 that connects the right elbow A41 and the right hand A 51 and a bone B42 that connects the left elbow A42 and the left hand A52, a bone B51 that connects the neck A2 and the right waist A61 and a bone B52 that connects the neck A2 and the left waist A62, a bone B61 that connects the right waist A61 and the right knee A71 and a bone B62 that connects the left waist 62 and the left knee A72, and a bone B71 that connects the right knee A71 and the right foot A81 and a bone B72 that connects the left knee A72 and the left foot A82. The skeletal structure detection unit 102 stores the skeletal structure of the detected person in the database 201.

FIG. 8 is an example of detecting a person in an upright state. In FIG. 8, an image of an upright person is captured from the front, the bone B1, the bone B51 and the bone B52, the bone B61 and the bone B62, the bone B71 and the bone B72 viewed from the front are detected without overlapping each other, and the bone B61 and the bone B71 of the right foot are slightly bent more than the bone B62 and the bone B72 of the left foot.

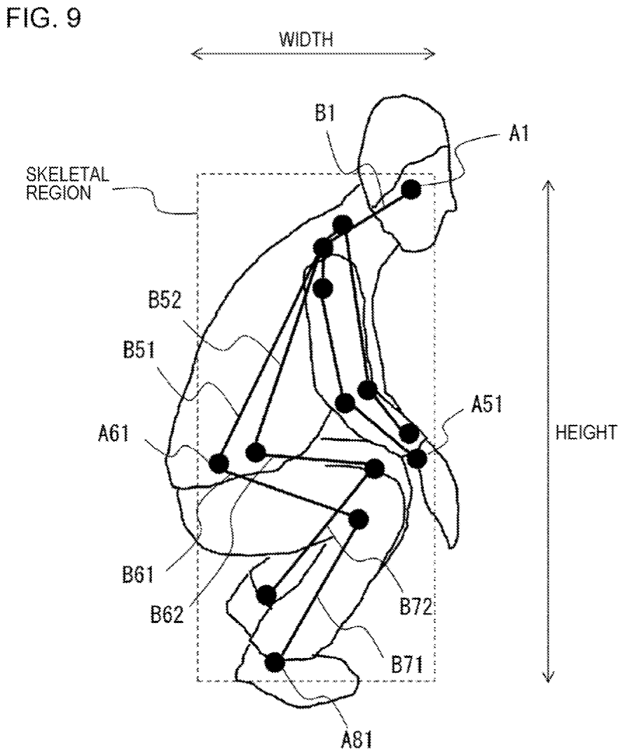

FIG. 9 is an example of detecting a person in a squatted state. In FIG. 9, an image of a person who squats down is captured from a right side, and each of the bone B1, the bone B51 and the bone B52, the bone B61 and the bone B62, and the bone B71 and the bone B72 viewed from the right side is detected, and the bone B61 and bone B71 of the right foot and the bone B62 and bone B72 of the left foot are greatly bent and overlapped.

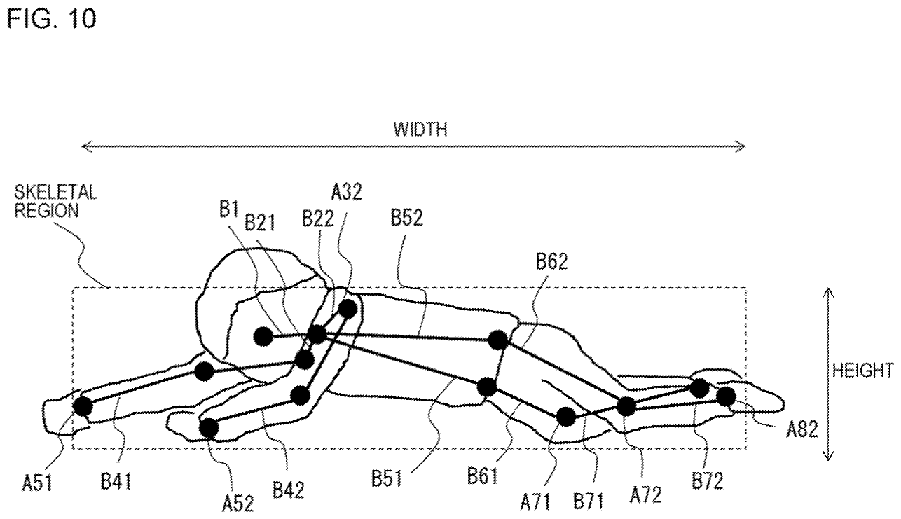

FIG. 10 is an example of detecting a person in a lying down state. In FIG. 10, an image of the person who is lying down is captured from a left oblique front, each of the bone B1, the bone B51 and the bone B52, the bone B61 and the bone B62, and the bone B71 and the bone B72 viewed from the left oblique front is detected, and the bone B61 and the bone B71 of the right foot and the bone B62 and the bone B72 of the left foot are bent and overlapped.

Subsequently, as illustrated in FIG. 3, the image processing apparatus 100 computes a feature value of the detected skeletal structure (S103). For example, in a case where a height and an area of a skeletal region are set as feature values, the feature value computation unit 103 extracts a region including the skeletal structure and acquires the height (the number of pixels) and the area (pixel area) of the region. The height and area of the skeletal region are acquired from coordinates of an end portion of the skeletal region to be extracted and coordinates of a keypoint of the end portion. The feature value computation unit 103 stores the acquired feature value of the skeletal structure in the database 201.

In the example of FIG. 8, a skeletal region including all bones is extracted from a skeletal structure of an upright person. In this case, an upper end of the skeletal region is the keypoint A1 of the head, a lower end of the skeletal region is the keypoint A82 of the left foot, a left end of the skeletal region is the keypoint A41 of the right elbow, and a right end of the skeletal region is a keypoint A52 of the left hand. Therefore, a height of the skeletal region is acquired from a difference between Y coordinates of the keypoint A1 and the keypoint A82. Further, a width of the skeletal region is acquired from a difference between X coordinates of the keypoint A41 and the keypoint A52, and an area is acquired from the height and the width of the skeletal region.

In the example of FIG. 9, a skeletal region including all bones is extracted from a skeletal structure of a squatted person. In this case, an upper end of the skeletal region is the keypoint A1 of the head, a lower end of the skeletal region is the keypoint A81 of the right foot, a left end of the skeletal region is the keypoint A61 of the right waist, and a right end of the skeletal region is the keypoint A51 of the right hand. Therefore, a height of the skeletal region is acquired from a difference between Y coordinates of the keypoint A1 and the keypoint A81. Further, a width of the skeletal region is acquired from a difference between X coordinates of the keypoint A61 and the keypoint A51, and an area is acquired from the height and the width of the skeletal region.

In the example of FIG. 10, a skeletal region including all bones is extracted from a skeletal structure of a person lying down in a left-right direction of an image. In this case, an upper end of the skeletal region is the keypoint A32 of the left shoulder, a lower end of the skeletal region is a keypoint A52 of the left hand, a left end of the skeletal region is a keypoint A51 of the right hand, and a right end of the skeletal region is a keypoint A82 of the left foot. Therefore, a height of the skeletal region is acquired from a difference between Y coordinates of the keypoint A32 and the keypoint A52. Further, a width of the skeletal region is acquired from a difference between X coordinates of the keypoint A51 and the keypoint A82, and an area is acquired from the height and the width of the skeletal region.

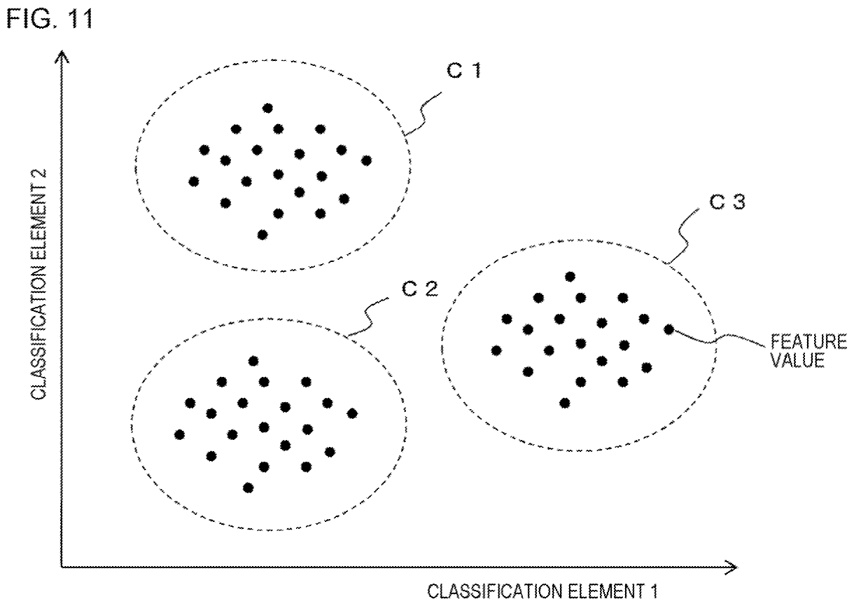

Subsequently, as illustrated in FIG. 3, the image processing apparatus 100 performs classification processing (S104). In the classification processing, as illustrated in FIG. 4, the classification unit 104 computes a similarity of the computed feature value of the skeletal structure (S111), and classifies the skeletal structure, based on the computed feature value (S112). The classification unit 104 acquires the similarities of the feature values among all the skeletal structures stored in the database 201 as the classification targets, and classifies (clusters) the skeletal structure (pose) having the highest similarity into the same cluster. Further, the similarity between the classified clusters is acquired and classified, and the classification is repeated until a predetermined number of clusters are acquired. FIG. 11 illustrates an image of the classification result of the feature value of the skeletal structure. FIG. 11 is an image of cluster analysis by a two-dimensional classification element, where the two classification elements are, for example, the height of the skeletal region, the area of the skeletal region, or the like. In FIG. 11, as a result of the classification, the feature values of the plurality of skeletal structures are classified into three clusters C1 to C3. The clusters C1 to C3 are associated to poses such as, for example, a standing pose, a sitting pose, and a sleeping pose, and the skeletal structure (person) is classified for each similar pose.

In the present example embodiment, various classification methods can be used by classifying based on the feature value of the skeletal structure of the person. The classification method may be set in advance or may be arbitrarily set by a user. Further, the classification may be performed by the same method as the search method to be described later. In short, it may be classified according to a classification condition similar to the search condition. For example, the classification unit 104 performs classification by the following classification method. Any of classification methods may be used, or any selected classification methods may be combined.

### (Classification Method 1)

Classification by a skeletal structure of a whole body classified by multiple hierarchies, classification by a skeletal structure of an upper body and a lower body, classification by a skeletal structure of arms and legs, and the like are hierarchically combined and classified. Namely, it may be classified based on feature values of the first portion and the second portion of the skeletal structure, and may be further classified by weighting the feature values of the first portion and the second portion.

### (Classification Method 2)

A classification is performed based on a feature value of a skeletal structure in a plurality of images that are consecutive in a classification time series by a plurality of images along a time series. For example, the feature values may be accumulated in a time series direction and classified based on cumulative values. Further, classification may be performed based on a change (amount of change) in the feature value of the skeletal structure in the plurality of consecutive images.

### (Classification Method 3)

A skeletal structure in which a right side and a left side of a classified person ignoring left and right of the skeletal structure are opposite to each other is classified as the same skeletal structure.

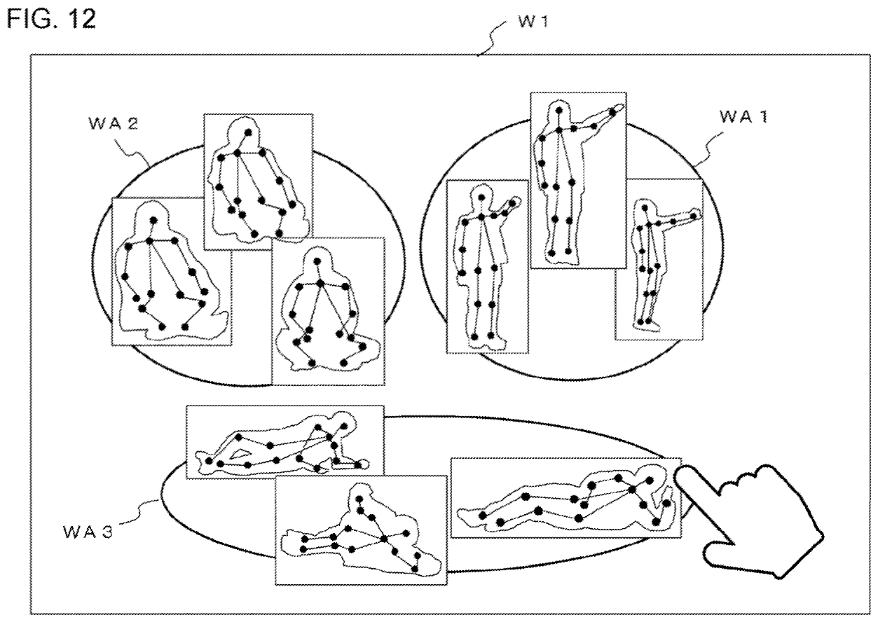

Further, the classification unit 104 displays a classification result of the skeletal structure (S113). The classification unit 104 acquires an image of a necessary skeletal structure and a necessary person from the database 201, and displays the skeletal structure and the person on the display unit 107 for each similar pose (cluster) as a classification result. FIG. 12 illustrates a display example when a pose is classified into three. For example, as illustrated in FIG. 12, pose regions WA1 to WA3 for each pose are displayed in a display window W1, and a skeletal structure and a person (image) of a pose falling under each of the pose regions WA1 to WA3 are displayed. The pose region WA1 is, for example, a display region of a standing pose, and displays a similar skeletal structure and person to the standing pose, which are classified into the cluster C1. The pose region WA2 is, for example, a display region of a sitting pose, and displays a similar skeletal structure and person to the sitting pose, which are classified into the cluster C2. The pose region WA3 is, for example, a display region of a sleeping pose, and displays a similar skeletal structure and person to the sleeping pose, which are classified into the cluster C2.

Subsequently, as illustrated in FIG. 3, the image processing apparatus 100 performs search processing (S105). In the search processing, as illustrated in FIG. 5, the search unit 105 receives an input of a search condition (S121), and searches for a skeletal structure, based on the search condition (S122). The search unit 105 receives, from the input unit 106, an input of a search query that is a search condition in response to an operation by the user. When the search query is input from the classification result, for example, in the display example of FIG. 12, the user specifies (selects) the skeletal structure of the pose desired to be searched from among the pose regions WA1 to WA3 being displayed in the display window W1. Then, the search unit 105 searches for a skeletal structure having a high similarity of feature values from among all the skeletal structures stored in the database 201, which is the search target, by using the skeletal structure specified by the user as the search query. The search unit 105 computes a similarity between the feature value of the skeletal structure of the search query and the feature value of the skeletal structure of the search target, and extracts a skeletal structure in which the computed similarity is higher than a predetermined threshold. As the feature value of the skeletal structure of the search query, a feature value computed in advance may be used, or a feature value acquired at the time of search may be used. Note that the search query may be input by moving each part of the skeletal structure in response to an operation by the user, or a pose performed by the user in front of the camera may be used as the search query.

In the present example embodiment, as in the classification method, various search methods can be used by searching based on the feature value of the skeletal structure of the person. The search method may be set in advance or may be optionally set by the user. For example, the search unit 105 performs a search by the following search method. Any of search methods may be used, or an optionally selected search method may be combined. A plurality of search methods (search conditions) may be combined and searched by a logical expression (for example, AND (logical product), OR (logical sum), NOT (negative)). For example, the search condition may be searched as “(a pose in which the right hand is raised) AND (a pose in which the left foot is raised)”.

### (Search Method 1)

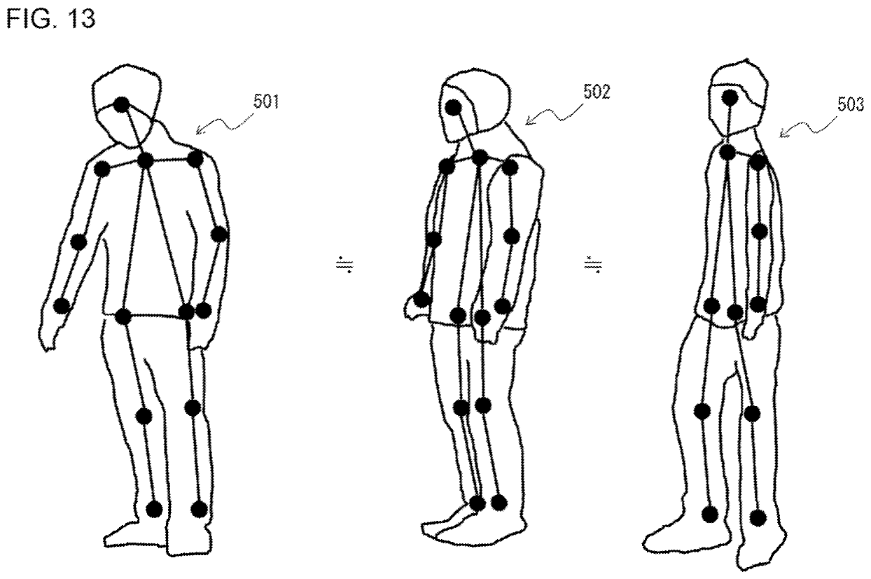

By searching using only a feature value in a height direction of a person searched based on only a feature value in a height direction, an influence of change in a lateral direction of the person can be suppressed, and robustness against a change in an orientation of the person and a body shape of the person is improved. For example, as in the skeletal structures 501 to 503 in FIG. 13, even when orientations and body shapes of persons are different, the feature value in the height direction does not change greatly. Therefore, it can be determined that the skeletal structures 501 to 503 have the same pose at the time of search (at the time of classification).

### (Search Method 2)

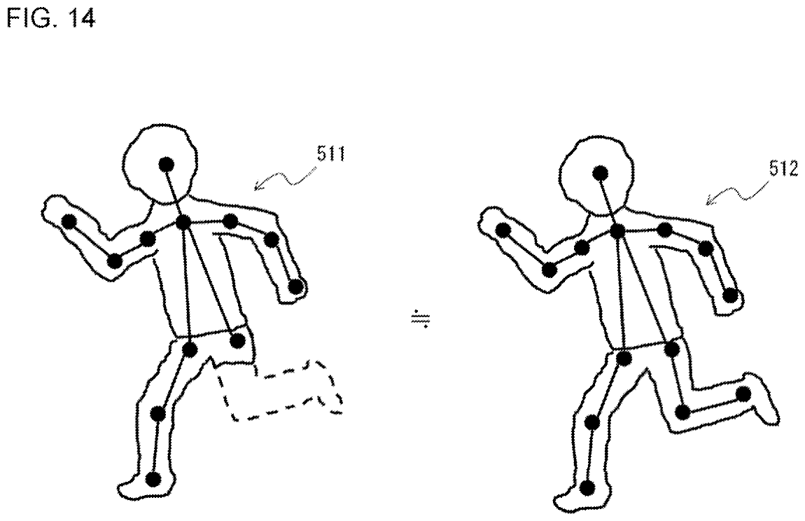

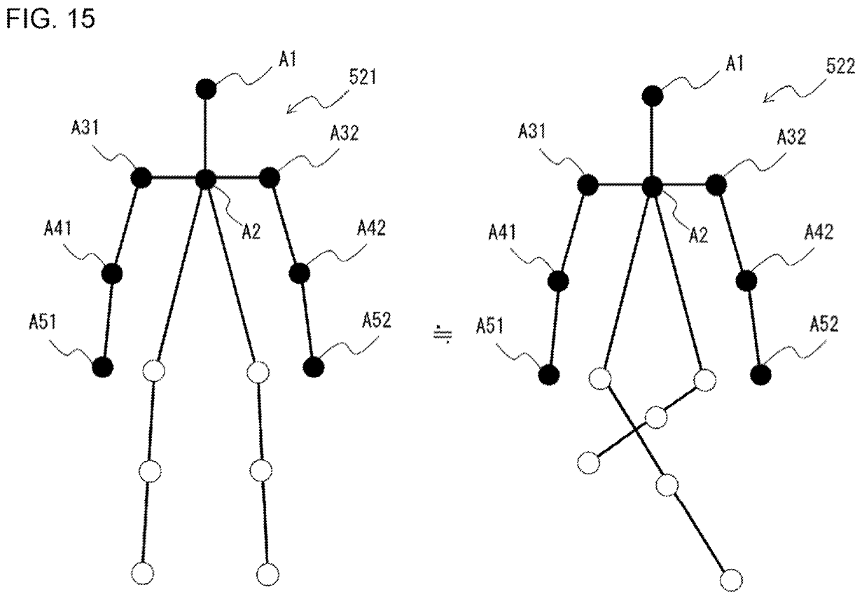

When a part of the body of a person is hidden in a partial search image, a search is performed by using only information of a recognizable part. For example, as in the skeletal structures 511 and 512 in FIG. 14, even when the keypoint of the left foot cannot be detected due to the left foot being hidden, it is possible to search by using feature values of other detected keypoints. Therefore, it can be determined that the skeletal structures 511 and 512 have the same pose at the time of search (at the time of classification). In short, classification and search can be performed by using feature values of some keypoints instead of all keypoints. In the example of the skeletal structures 521 and 522 in FIG. 15, although orientations of both feet are different from each other, it is possible to determine that the poses are the same by using a feature value of the keypoint (A1, A2, A31, A32, A41, A42, A51, A52) of the upper body as a search query. Further, the portion (feature point) desired to be searched may be searched by weighting, or a threshold of the similarity determination may be changed. When a part of the body is hidden, the hidden portion may be ignored for searching, or the hidden portion may be added for searching. By searching including the hidden portion, it is possible to search for a pose in which the same part is hidden.

### (Search Method 3)

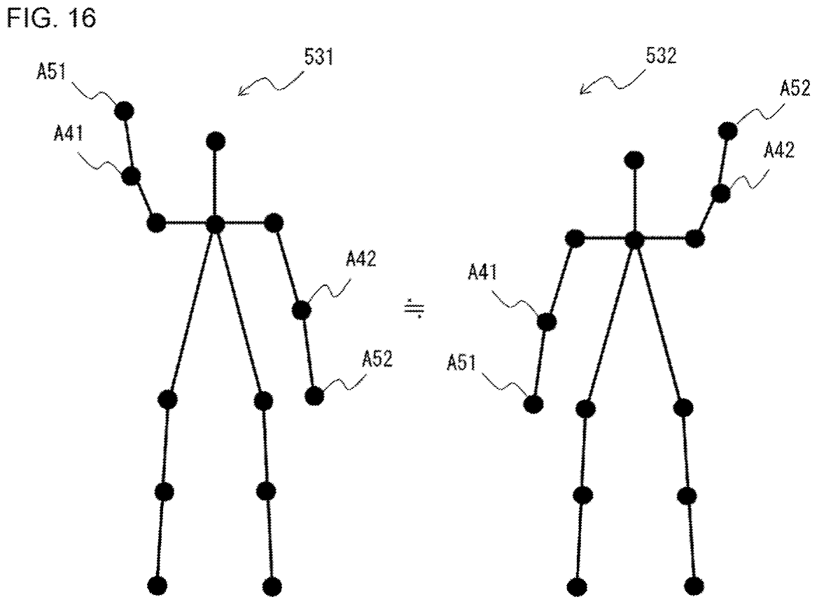

The skeletal structure in which a right side and a left side of a search person who ignores left and right of the skeletal structure is opposite to each other is searched as the same skeletal structure. For example, as in the skeletal structures 531 and 532 in FIG. 16, the pose in which the right hand is raised and the pose in which the left hand is raised can be searched (classified) as the same pose. In the example of FIG. 16, the skeletal structure 531 and the skeletal structure 532 have different positions of the right-hand keypoint A51, the right-elbow keypoint A41, the left-hand keypoint A52, and the left-elbow keypoint A42, but other keypoints are in the same position. When a keypoint of one skeletal structure out of the keypoint A51 of the right hand and the keypoint A41 of the right elbow of the skeletal structure 531, and the keypoint A52 of the left hand and the keypoint A42 of the left elbow of the skeletal structure 532 are left-right inverted, the keypoint of the one skeletal structure is in the same position as the keypoint of another skeletal structure, and when the keypoint of the one skeletal structure out of the keypoint A52 of the left hand and the keypoint A42 of the left elbow of the skeletal structure 531 and the keypoint A51 of the right hand and the keypoint A41 of the right elbow of the skeletal structure 532 are left-right inverted, the keypoint of the one skeletal structure is in the same position as the keypoint of the another skeletal structure, and therefore, it is determined that they have the same pose.

### (Search Method 4)

After the search is performed using only the feature value in the vertical direction (Y-axis direction) of the search person based on the feature values in the vertical direction and the horizontal direction, the acquired result is further searched by using the feature value in the horizontal direction (X-axis direction) of the person.

### (Search Method 5)

A search is performed based on a feature value of a skeletal structure in a plurality of images consecutive in a search time series by a plurality of images along a time series. For example, the feature values may be accumulated in a time series direction and searched based on cumulative values. Further, the search may be performed based on a change (amount of change) in the feature value of the skeletal structure in a plurality of consecutive images.

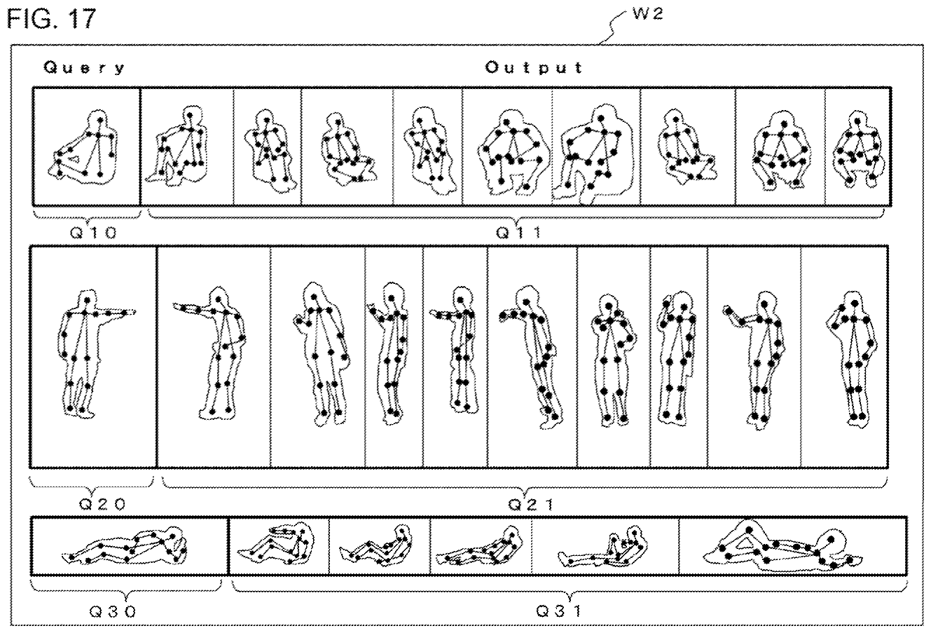

Further, the search unit 105 displays a search result of the skeletal structure (S123). The search unit 105 acquires an image of a necessary skeletal structure and a necessary person from the database 201, and displays the skeletal structure and the person acquired as a search result on the display unit 107. For example, when a plurality of search queries (search conditions) are specified, the search results are displayed for each search query. FIG. 17 illustrates a display example in a case of searching by three search queries (poses). For example, as illustrated in FIG. 17, in a display window W2, skeletal structures and persons of search queries Q10, Q20, Q30 specified at the left end portion are displayed, and skeletal structures and persons of search results Q11, Q21, Q31 of the search queries Q10, Q20, Q30 are displayed side by side on the right side of the search queries.

An order in which the search results are displayed side by side from the next side of the search query may be an order in which the relevant skeletal structures are found, or may be an order in which the similarity is high. When a search is performed by weighting a portion (feature point) of partial search, the portions may be displayed in an order of similarity computed by weighting. It may be displayed in the order of similarity computed from only the part (feature point) selected by a user. In addition, images (frames) before and after the time series may be cut out for a certain period of time and displayed around the image (frame) of the search result.

As described above, in the present example embodiment, the skeletal structure of a person can be detected from the two-dimensional image, and classification and search can be performed based on the feature value of the detected skeletal structure. As a result, it is possible to classify each similar pose having a high degree of similarity, and it is possible to search for a similar pose having a high degree of similarity to a search query (search key). By classifying and displaying a similar pose from the image, the user can recognize the pose of the person in the image without specifying the pose or the like. Since the user can specify the pose of the search query from among the classification results, the desired pose can be searched even when the pose that the user desires to search is not recognized in detail in advance. For example, it is possible to perform classification or search on the whole, a part, or the like of the skeletal structure of a person as a condition, and thus it is possible to perform flexible classification or search.

### Second Example Embodiment

Hereinafter, a second example embodiment will be explained with reference to the drawings. In the present example embodiment, a specific example of the feature value computation in the first example embodiment will be explained. In the present example embodiment, a feature value is acquired by normalizing using a height of a person. Others are the same as those in the first example embodiment.

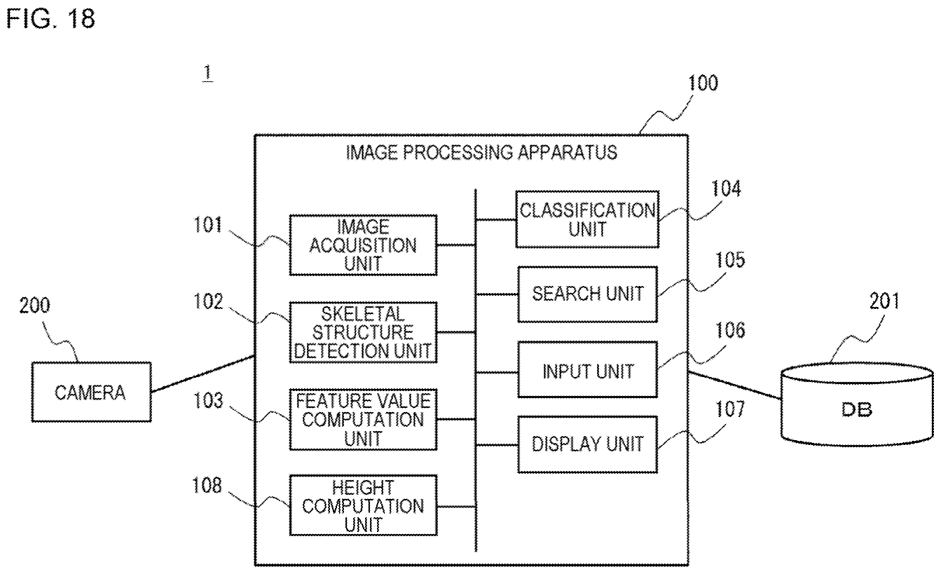

FIG. 18 illustrates a configuration of an image processing apparatus 100 according to the present example embodiment. As illustrated in FIG. 18, the image processing apparatus 100 further includes a height computation unit 108 in addition to the configuration of the first example embodiment. Note that a feature value computation unit 103 and the height computation unit 108 may be one processing unit.

The height computation unit (height estimation unit) 108 computes (estimates) a height of a person in an upright position in a two-dimensional image (referred to as the number of height pixels), based on a two-dimensional skeletal structure detected by the skeletal structure detection unit 102. The number of height pixels can also be said to be the height of the person in the two-dimensional image (a length of the whole body of the person in the two-dimensional image space). The height computation unit 108 acquires the number of height pixels (the number of pixels) from a length (a length in the two-dimensional image space) of each bone of the detected skeletal structure.

In the following examples, specific examples 1 to 3 are used as a method of acquiring the number of height pixels. The method of any one of the specific examples 1 to 3 may be used, or a plurality of optionally selected methods may be used in combination. In the specific example 1, the number of height pixels is acquired by summing lengths of bones from a head to a foot among the bones of the skeletal structure. When the skeletal structure detection unit 102 (skeletal estimation technique) does not output the top of head and foot, it may be corrected by multiplying by a constant as necessary. In the specific example 2, the number of height pixels is computed by using a human body model indicating a relationship between the length of each bone and the length of the whole body (height in the two-dimensional image space). In the specific example 3, the number of height pixels is computed by fitting (applying) a three-dimensional human body model to a two-dimensional skeletal structure.

The feature value computation unit 103 of the present example embodiment is a normalization unit that normalizes a skeletal structure (skeletal information) of a person, based on the computed number of height pixels of the person. The feature value computation unit 103 stores the normalized feature value (normalized value) of the skeletal structure in the database 201. The feature value computation unit 103 normalizes a height of each keypoint (feature point) included in the skeletal structure on the image by the number of height pixels. In the present example embodiment, for example, a height direction is an up-down direction (Y-axis direction) in the two-dimensional coordinate (X-Y coordinate) space of the image. In this case, the height of the keypoint can be acquired from a value (the number of pixels) of the Y coordinate of the keypoint. Alternatively, the height direction may be a direction of a vertical projection axis (vertical projection direction) in which a direction of a vertical axis that is perpendicular to a ground (reference plane) in a three-dimensional coordinate space of the real world is projected onto the two-dimensional coordinate space. In this case, the height of the keypoint can be acquired from a value (number of pixels) along a vertical projection axis, which is acquired by projecting an axis perpendicular to the ground in the real world onto a two-dimensional coordinate space, based on camera parameters. Note that the camera parameter is an imaging parameter of an image, and for example, the camera parameter is a pose, a position, an imaging angle, a focal length, or the like of the camera 200. The camera 200 can capture an image of an object whose length and position are known in advance, and acquire camera parameters from the image. Distortion may occur at both ends of the captured image, and the vertical direction of the real world may not match the up-down direction of the image. On the other hand, by using the parameters of the camera that has captured the image, it is possible to know how much the vertical direction of the real world is inclined in the image. Therefore, by normalizing the value of the keypoint along the vertical projection axis projected in the image, based on the camera parameters by the height, the keypoint can be converted into a feature value in consideration of a deviation between the real world and the image. Note that a left-right direction (lateral direction) is a left-right direction (X-axis direction) in the two-dimensional coordinate (X-Y coordinate) space of the image or a direction acquired by projecting a direction parallel to the ground in the three-dimensional coordinate space of the real world onto the two-dimensional coordinate space.

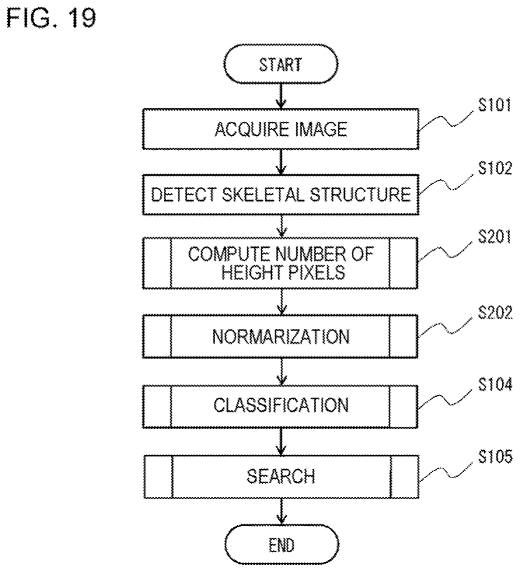

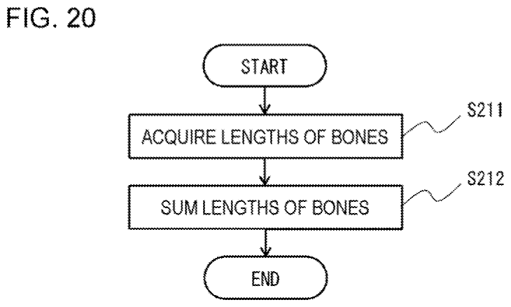

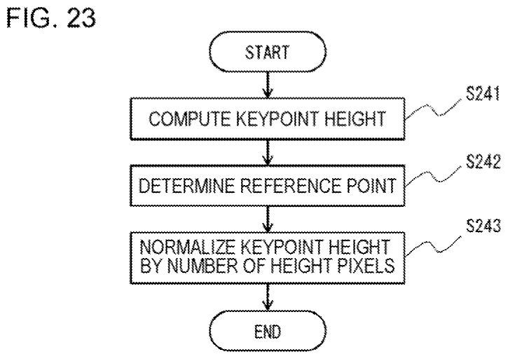

FIGS. 19 to 23 illustrate operations of the image processing apparatus 100 according to the present example embodiment. FIG. 19 illustrates a flow from image acquisition to search processing in the image processing apparatus 100, FIGS. 20 to 22 illustrate a flow of specific examples 1 to 3 of height pixel number computation processing (S201) in FIG. 19, and FIG. 23 illustrates a flow of normalization processing (S202) in FIG. 19.

As illustrated in FIG. 19, in the present example embodiment, as the feature value computation processing (S103) in the first example embodiment, the height pixel number computation processing (S201) and the normalization processing (S202) are performed. Others are the same as those in the first example embodiment.

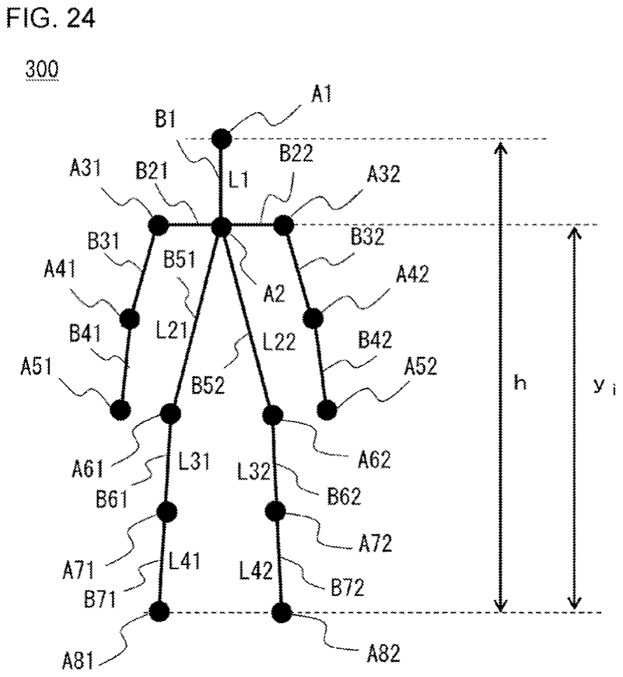

Following the image acquisition (S101) and the skeletal structure detection (S102), the image processing apparatus 100 performs height pixel number computation processing, based on the detected skeletal structure (S201). In this example, as illustrated in FIG. 24, a height of the skeletal structure of a person in an upright position in an image is defined as the number of height pixels (h), and a height of each keypoint of the skeletal structure in the state of the person in the image is defined as a keypoint height (yi). Specific examples 1 to 3 of the height pixel number computation processing will be explained below.

### Specific Example 1

In a specific example 1, the number of height pixels is acquired by using lengths of bones from a head to a foot. In the specific example 1, as illustrated in FIG. 20, the height computation unit 108 acquires a length of each bone (S211), and sums the acquired lengths of the bones (S212).

The height computation unit 108 acquires lengths of bones from a head to a foot of a person on a two-dimensional image, and acquires the number of height pixels. Namely, lengths (the number of pixels) of a bone B1 (a length L1), a bone B51 (a length L21), a bone B61 (a length L31), a bone B71 (a length L41), or a bone B1 (a length L1), a bone B52 (a length L22), a bone B62 (a length L32), and a bone B72 (a length L42) are acquired from an image in which a skeletal structure is detected, among the bones in FIG. 24. The length of each bone can be acquired from coordinates of each keypoint in the two-dimensional image. A value acquired by multiplying L1+L21+L31+L41 or L1+L22+L32+L42, which are the sum of these bones, by a correction constant is computed as the number of height pixels (h). In a case where both values can be computed, for example, the longer value is set as the number of height pixels. Namely, when an image of each bone is captured from the front, the length in the image becomes the longest, and when the bone is inclined in a depth direction with respect to the camera, the bone is displayed short. Therefore, it is highly likely that an image of a long bone is captured from the front, and it is considered to be close to a true value. Therefore, it is desirable to select the longer value.

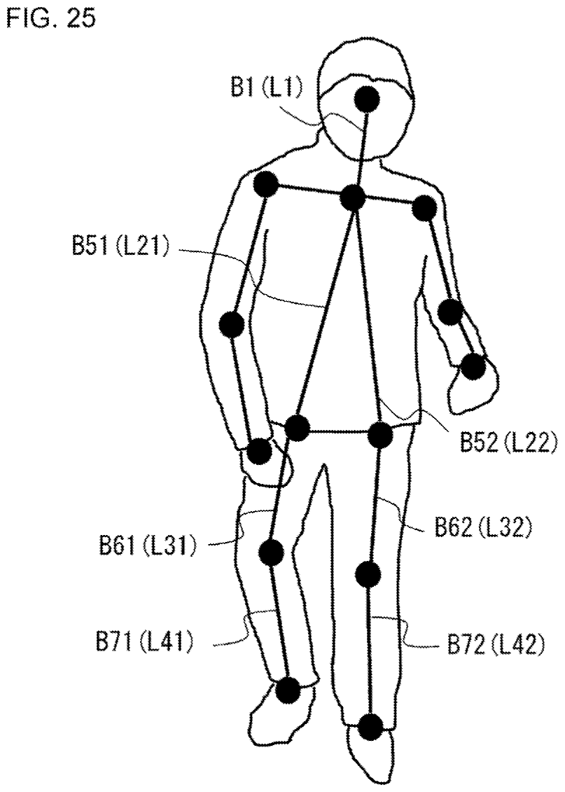

In the example of FIG. 25, the bone B1, the bone B51 and the bone B52, the bone B61 and the bone B62, and the bone B71 and the bone B72 are detected without overlapping. L1+L21+L31+L41 and L1+L22+L32+L42, which are the sum of these bones, are acquired, and a value acquired by multiplying, for example, L1+L22+L32+L42 on a left foot side where the detected length of the bone is long by a correction constant is set as the number of height pixels.

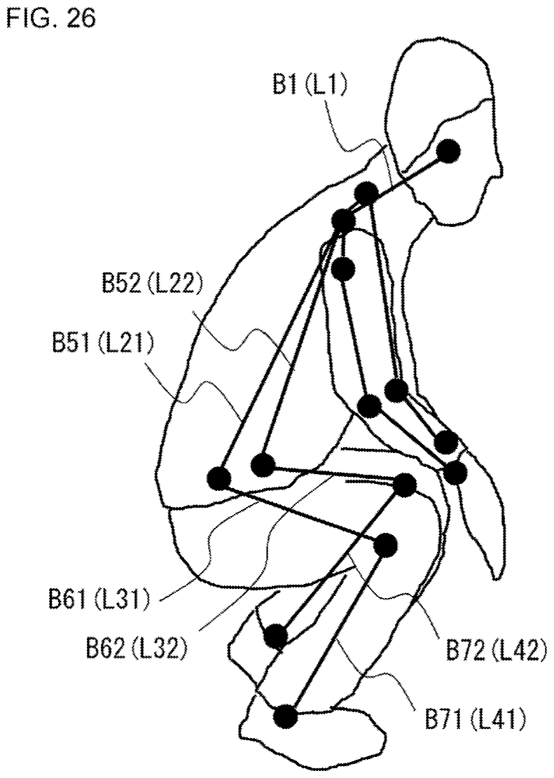

In the example of FIG. 26, the bone B1, the bone B51 and the bone B52, the bone B61 and the bone B62, and the bone B71 and the bone B72 are each detected, and the bone B61 and the bone B71 of the right foot and the bone B62 and the bone B72 of the left foot overlap each other. L1+L21+L31+L41 and L1+L22+L32+L42, which are the sum of these bones, are acquired, and a value acquired by multiplying, for example, L1+L21+L31+L41 on a right foot side where a length of the detected bone is longer by a correction constant is set as the number of height pixels.

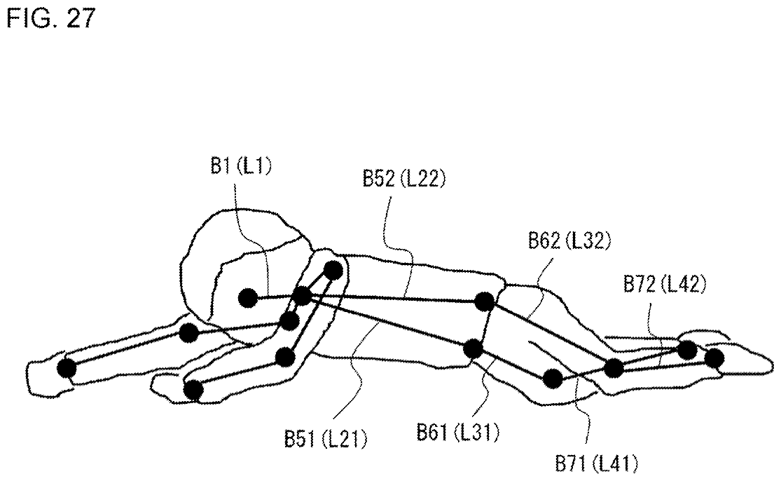

In the example of FIG. 27, the bone B1, the bone B51 and the bone B52, the bone B61 and the bone B62, and the bone B71 and the bone B72 are each detected, and the bone B61 and the bone B71 of the right foot and the bone B62 and the bone B72 of the left foot overlap each other. L1+L21+L31+L41 and L1+L22+L32+L42, which are the sum of these bones, are acquired, and a value acquired by multiplying, for example, L1+L22+L32+L42 on the left foot side where the detected length of the bone is longer by a correction constant is set as the number of height pixels.

In the specific example 1, since the height can be acquired by summing the lengths of the bones from the head to the foot, the number of height pixels can be acquired by a simple method. Further, since it is only necessary to detect at least the skeleton from the head to the foot by the skeletal estimation technique using machine learning, it is possible to accurately estimate the number of height pixels even when the whole of the person is not necessarily captured in the image, such as a state in which the person is squatted.

### Specific Example 2

In a specific example 2, the number of height pixels is acquired by using a two-dimensional skeletal model indicating a relationship between a length of a bone included in a two-dimensional skeletal structure and a length of the whole body of a person in a two-dimensional image space.

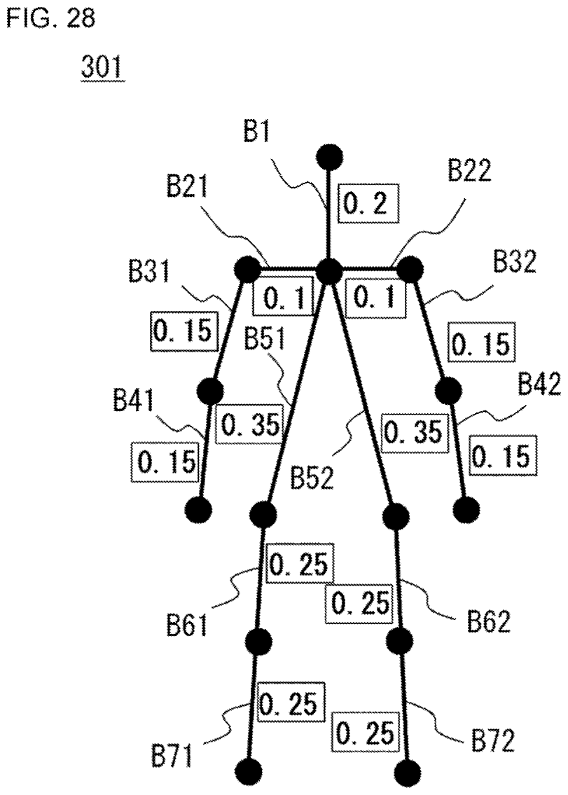

FIG. 28 is a human body model (two-dimensional skeletal model) 301 indicating a relationship between a length of each bone in a two-dimensional image space and a length of the whole body in the two-dimensional image space, which is used in the specific example 2. As illustrated in FIG. 28, the relationship between the length of each bone of an average person and the length of the whole body thereof (a ratio of the length of each bone to the length of the whole body) is associated with each bone of the human body model 301. For example, the length of the bone B1 of the head is the length of the whole body×0.2 (20%), a length of a bone B41 of the right hand is the length of the whole body×0.15 (15%), and the length of the bone B71 of the right foot is the length of the whole body×0.25 (25%). By storing information of the human body model 301 in the database 201, an average length of the whole body can be acquired from the length of each bone. In addition to the human body model of the average person, a human body model may be prepared for each attribute of the person such as age, sex, and nationality. This makes it possible to acquire the length (height) of the whole body appropriately in accordance with the attribute of the person.

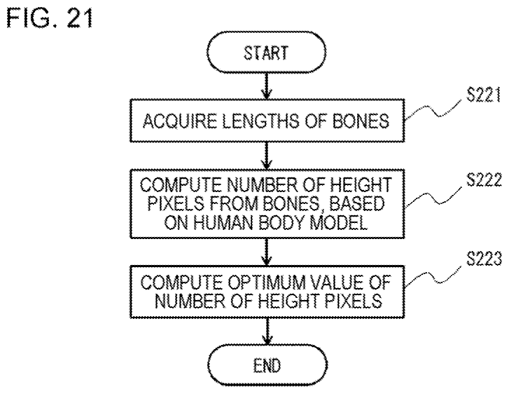

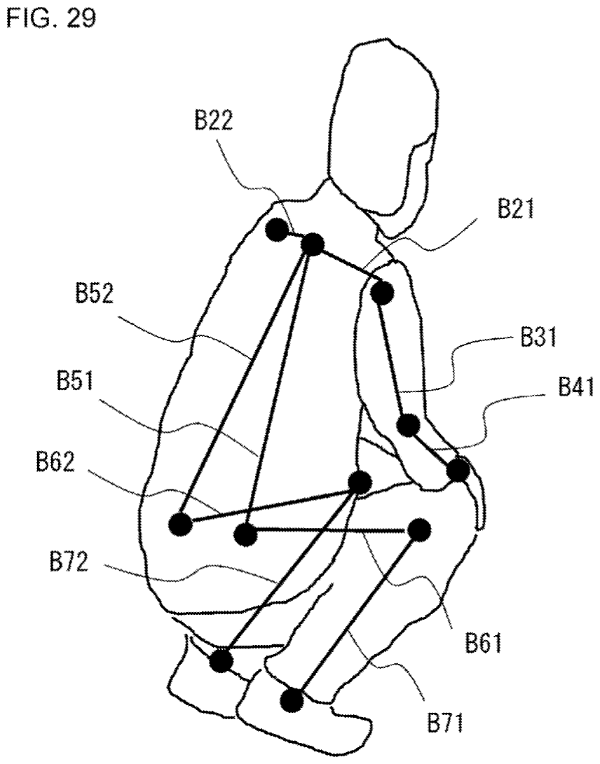

In the specific example 2, as illustrated in FIG. 21, the height computation unit 108 acquires the length of each bone (S221). The height computation unit 108 acquires lengths of all bones (lengths in the two-dimensional image space) in the detected skeletal structure. FIG. 29 is an example in which an image of a person in a squatted state is captured from right oblique back and a skeletal structure is detected. In this example, since the face or the left side of the person is not captured in the image, the bone of the head and bones of a left arm and a left hand cannot be detected. Therefore, lengths of the bones B21, B22, B31, B41, B51, B52, B61, B62, B71, and B72 being detected are acquired.

Subsequently, as illustrated in FIG. 21, the height computation unit 108 computes the number of height pixels from the length of each bone, based on a human body model (S222). The height computation unit 108 refers to a human body model 301 indicating a relationship between each bone and a length of the whole body, as in FIG. 28, and acquires the number of height pixels from the length of each bone. For example, since the length of the bone B41 of the right hand is the length of the whole body×0.15, the number of height pixels based on the bone B41 is acquired by the length of the bone B41/0.15. Further, since the length of the bone B71 of the right foot is the length of the whole body×0.25, the number of height pixels based on the bone B71 is acquired by the length of the bone B71/0.25.

The human body model to be referred to at this time is, for example, a human body model of an average person, but the human body model may be selected according to attributes of the person, such as age, gender, and nationality. For example, when a face of a person is captured in a captured image, the attribute of the person is discriminated based on the face, and the human body model associated to the discriminated attribute is referred to. It is possible to recognize the attribute of the person from the feature of the face in the image by referring to information acquired by machine learning the face for each attribute. In addition, in a case where the attribute of the person cannot be discriminated from the image, the human body model of the average person may be used.

Further, the number of height pixels computed from the length of the bone may be corrected by a camera parameter. For example, in a case where a camera is placed at a high position and photographs a person in such a way as to look down on the person, a lateral length of a shoulder width bone or the like in a two-dimensional skeletal structure is not affected by a depression angle of the camera, but a longitudinal length of a neck-waist bone or the like decreases as the depression angle of the camera increases. In this case, the number of height pixels computed from the lateral length of the shoulder width bone or the like tends to be larger than the actual number. Therefore, when the camera parameters are utilized, it is possible to know at what angle the person is looked down on by the camera, and thus it is possible to correct the two-dimensional skeletal structure as photographed from the front by using information of the depression angle. Thus, the number of height pixels can be computed more accurately.

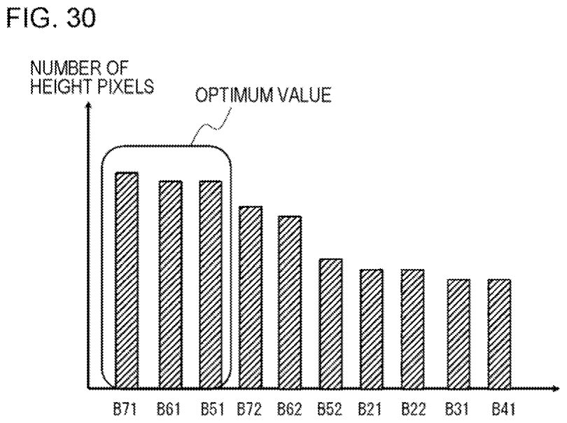

Subsequently, as illustrated in FIG. 21, the height computation unit 108 computes an optimum value of the number of height pixels (S223). The height computation unit 108 computes an optimum value of the number of height pixels from the number of height pixels acquired for each bone. For example, as illustrated in FIG. 30, a histogram of the number of height pixels acquired for each bone is generated, and the number of height pixels, which is larger, is selected in the histogram. In short, the number of height pixels longer than the others is selected from among a plurality of the numbers of height pixels acquired based on the plurality of bones. For example, the upper 30% is set to be a valid value, and in FIG. 30, the numbers of height pixels according to the bones B71, B61, and B51 are selected. The average of the selected numbers of height pixels may be acquired as an optimum value, or the largest number of height pixels may be set as an optimum value. In order to acquire a height from the length of the bone of the two-dimensional image, in a case where the bone is not captured from the front surface, i.e., in a case where an image of the bone is captured while being inclined in a depth direction as viewed from the camera, the length of the bone is shorter than in a case where an image of the bone is captured from the front. In this case, a value having a larger number of height pixels is more likely to be acquired by capturing an image from the front than a value having a smaller number of height pixels, and therefore, a larger value is set as an optimum value.

In the specific example 2, since the number of height pixels is acquired based on the bones of the detected skeletal structure by using the human body model indicating the relationship between the bone on the two-dimensional image space and the length of the whole body, the number of height pixels can be acquired from some bones even when all the skeletons from the head to the foot cannot be acquired. In particular, by adopting a larger value among values acquired from a plurality of bones, it is possible to accurately estimate the number of height pixels.

### Specific Example 3

In a specific example 3, the two-dimensional skeletal structure is fitted to a three-dimensional human body model (three-dimensional skeletal model), and a skeletal vector of a whole body is acquired by using the number of height pixels of the fitted three-dimensional human body model.

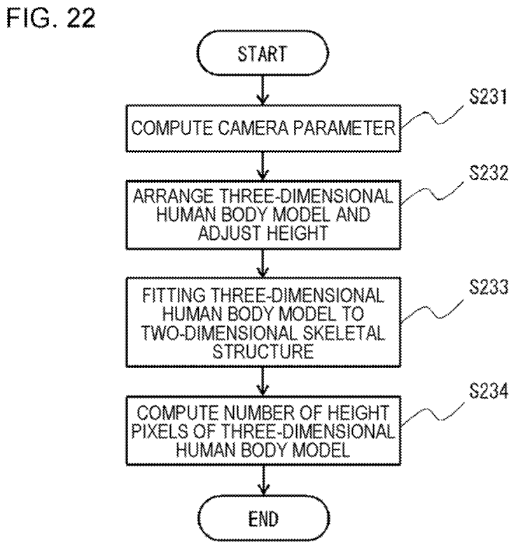

In the specific example 3, as illustrated in FIG. 22, the height computation unit 108 first computes a camera parameter, based on an image captured by the camera 200 (S231). The height computation unit 108 extracts an object whose length is known in advance from among a plurality of images captured by the camera 200, and acquires a camera parameter from a size (the number of pixels) of the extracted object. The camera parameters may be acquired in advance, and the acquired camera parameters may be acquired as necessary.

Subsequently, the height computation unit 108 arranges the three-dimensional human body model and adjusts a height of the three-dimensional human body model (S232). The height computation unit 108 prepares a three-dimensional human body model for computing the number of height pixels with respect to the detected two-dimensional skeletal structure, and arranges the three-dimensional human body model in the same two-dimensional image, based on the camera parameters. Specifically, a “relative positional relationship between a camera and a person in a real world” is determined from the camera parameters and the two-dimensional skeletal structure. For example, when a position of the camera is set to coordinates (0, 0, 0), coordinates (x, y, z) of a position where the person is standing (or sitting) are determined. Then, the two-dimensional skeletal structure and the three-dimensional human body model are superimposed on each other by assuming an image when being captured by arranging the three-dimensional human body model at the same position (x, y, z) as the determined person.

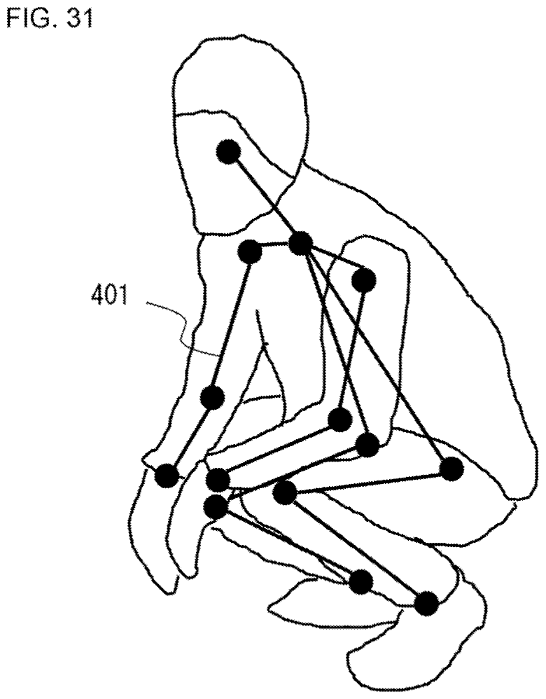

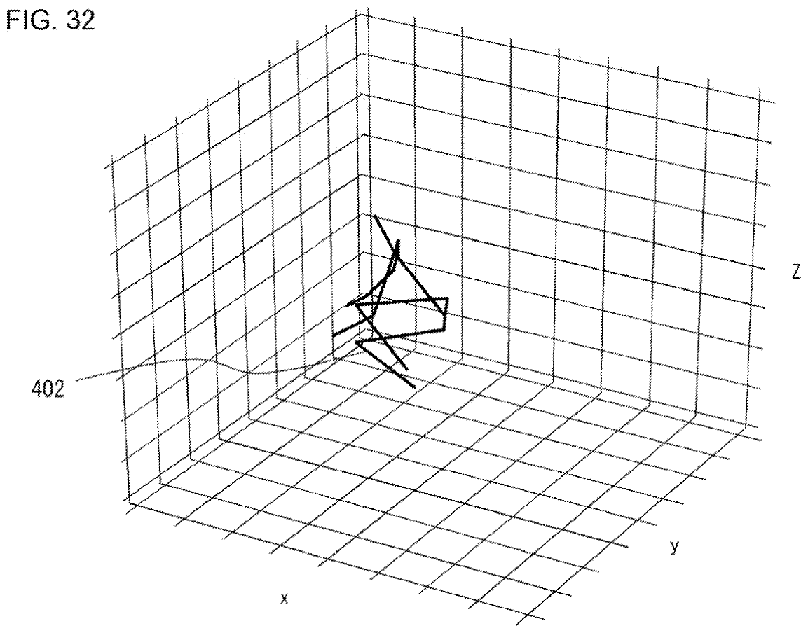

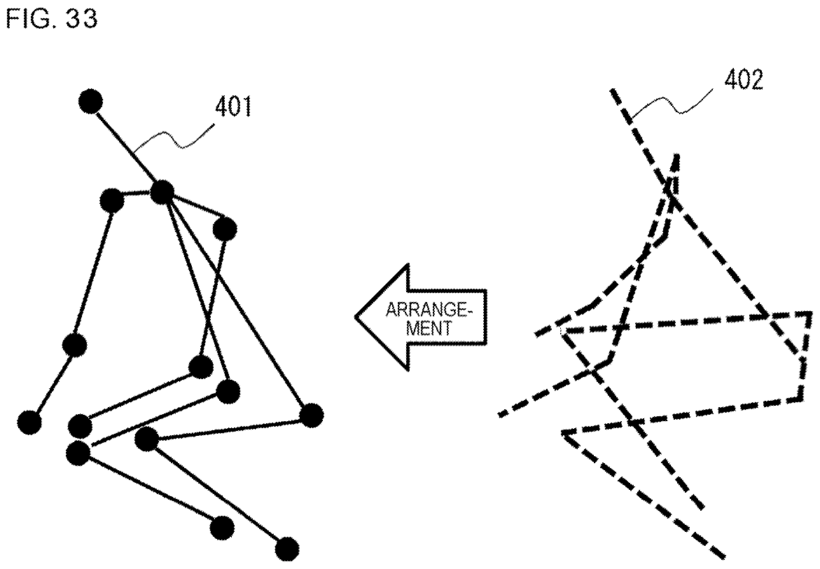

FIG. 31 is an example in which an image of a person who is squatting down is captured from a left oblique front and a two-dimensional skeletal structure 401 is detected. The two-dimensional skeletal structure 401 has two-dimensional coordinate information. It is desirable that all bones are detected, but some bones may not be detected. A three-dimensional human body model 402 as illustrated in FIG. 32 is prepared for the two-dimensional skeletal structure 401. A three-dimensional human body model (three-dimensional skeletal model) 402 has three-dimensional coordinate information and is a model of a skeleton having the same shape as the two-dimensional skeletal structure 401. Then, as illustrated in FIG. 33, the prepared three-dimensional human body model 402 is arranged and superimposed on the detected two-dimensional skeletal structure 401. In addition, with superimposing, a height of the three-dimensional human body model 402 is adjusted in such a way as to conform to the two-dimensional skeletal structure 401.

As illustrated in FIG. 33, the three-dimensional human body model 402 prepared at this time may be a model in a state close to the pose of the two-dimensional skeletal structure 401 or may be a model in an upright state. For example, the three-dimensional human body model 402 of the estimated pose may be generated by using a technique of estimating a pose in the three-dimensional space from the two-dimensional image using machine learning. By learning a joint in the two-dimensional image and information of a joint in the three-dimensional space, the three-dimensional pose can be estimated from the two-dimensional image.

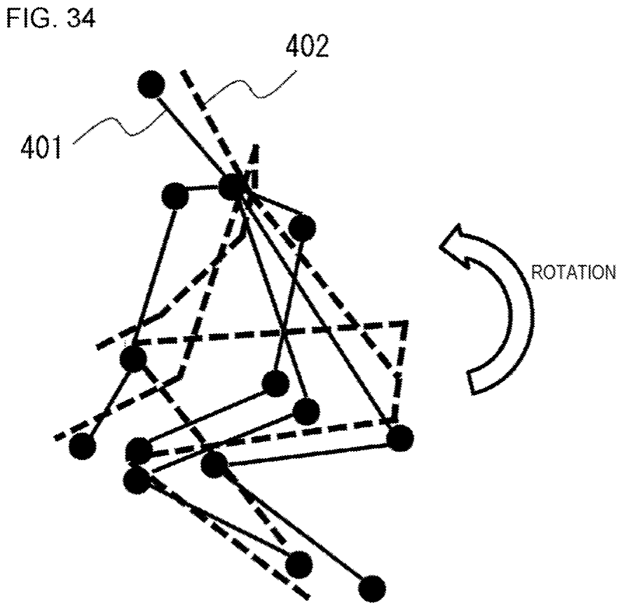

Subsequently, as illustrated in FIG. 22, the height computation unit 108 fits the three-dimensional human body model to the two-dimensional skeletal structure (S233). As illustrated in FIG. 34, the height computation unit 108 deforms the three-dimensional human body model 402 in such a way that the poses of the three-dimensional human body model 402 and the two-dimensional skeletal structure 401 coincide with each other in a state in which the three-dimensional human body model 402 is superimposed on the two-dimensional skeletal structure 401. Namely, a height, an orientation of the body, and an angle of the joint of the three-dimensional human body model 402 are adjusted and optimized in such a way as to eliminate a difference from the two-dimensional skeletal structure 401. For example, the joint of the three-dimensional human body model 402 is rotated within a movable range of the person, and the entire three-dimensional human body model 402 is rotated or the entire size is adjusted. The fitting (applying) of the three-dimensional human body model and the two-dimensional skeletal structure is performed in a two-dimensional space (two-dimensional coordinates). Namely, the three-dimensional human body model is mapped to the two-dimensional space, and the three-dimensional human body model is optimized to the two-dimensional skeletal structure in consideration of how the deformed three-dimensional human body model changes in the two-dimensional space (image).

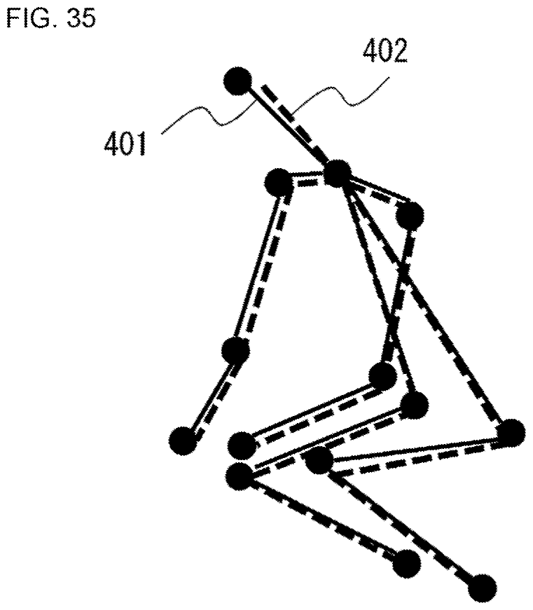

Subsequently, as illustrated in FIG. 22, the height computation unit 108 computes the number of height pixels of the fitted three-dimensional human body model (S234). As illustrated in FIG. 35, the height computation unit 108 acquires the number of height pixels of the three-dimensional human body model 402 in a state when there is no difference between the three-dimensional human body model 402 and the two-dimensional skeletal structure 401 and the poses coincide. As a state in which the optimized three-dimensional human body model 402 is erected, the length of the whole body in the two-dimensional space is acquired based on the camera parameters. For example, the number of height pixels is computed based on lengths (the number of pixels) of the bones from the head to the foot when the three-dimensional human body model 402 is erected. As in the specific example 1, the lengths of the bones from the head to the foot of the three-dimensional human body model 402 may be summed.

In the specific example 3, by fitting the three-dimensional human body model to the two-dimensional skeletal structure, based on the camera parameters and acquiring the number of height pixels based on the three-dimensional human body model, it is possible to accurately estimate the number of height pixels even in a case where all bones are not captured in front, i.e., in a case where errors are large because all bones are captured obliquely.

### <Normalization Processing>

As illustrated in FIG. 19, the image processing apparatus 100 performs normalization processing (S202) following the height pixel number computation processing. In the normalization processing, as illustrated in FIG. 23, the feature value computation unit 103 computes a keypoint height (S241). The feature value computation unit 103 computes keypoint heights (the number of pixels) of all the keypoints included in the detected skeletal structure. The keypoint height is a length (number of pixels) in a height direction from the lowermost end of the skeletal structure (for example, a keypoint of any foot) to the keypoint. Herein, as an example, the keypoint height is acquired from a Y coordinate of the keypoint in the image. As described above, the keypoint height may be acquired from a length in a direction along a vertical projection axis based on the camera parameters. For example, in the example of FIG. 24, a height (yi) of a keypoint A2 of a neck is a value acquired by subtracting a Y coordinate of a keypoint A81 of the right foot or a keypoint A82 of the left foot from a Y coordinate of the keypoint A2.

Subsequently, the feature value computation unit 103 determines a reference point for normalization (S242). The reference point is a reference point for representing a relative height of the keypoint. The reference point may be set in advance or may be selectable by the user. The reference point is desirably the center or higher than the center of the skeletal structure (the top of the image in the up-down direction), for example, the coordinates of the keypoint of the neck are used as the reference point. The coordinates of the head and other keypoints may be used as the reference point, not limited to the neck. The reference point is not limited to the keypoint, and may be any coordinate (for example, a center coordinate of the skeletal structure or the like).

Subsequently, the feature value computation unit 103 normalizes the keypoint height (yi) by the number of height pixels (S243). The feature value computation unit 103 normalizes each keypoint by using the keypoint height, the reference point, and the number of height pixels of each keypoint. Specifically, the feature value computation unit 103 normalizes the relative height of the keypoint with respect to the reference point by the number of height pixels. Herein, as an example of focusing only on the height direction, only the Y coordinate is extracted, and normalization is performed using the reference point as a keypoint of the neck. Specifically, the feature value (normalized value) is acquired by using the following equation (1) using the Y coordinate of the reference point (the keypoint of the neck) as (yc). When a vertical projection axis based on camera parameters is used, (yi) and (yc) are converted into values in a direction along the vertical projection axis.

[Mathematical 1]

fᵢ=(yᵢ−y_{c})/h (1)

For example, when the number of keypoints is 18, coordinates (x0, y0), (x1, y1), . . . (x17, y17) of 18 points of the keypoints are converted into 18-dimensional feature values by using the above-described equation (1) as follows.

$$[ Mathematical 2 ]$$

$$\begin{matrix}{f}_{0} = ( {y}_{0} - {y}_{c} ) / h & ( 2 )\end{matrix}$$

$${f}_{1} = ( {y}_{1} - {y}_{c} ) / h$$

$$⋮$$

$${f}_{17} = ( {y}_{17} - {y}_{c} \} / h$$

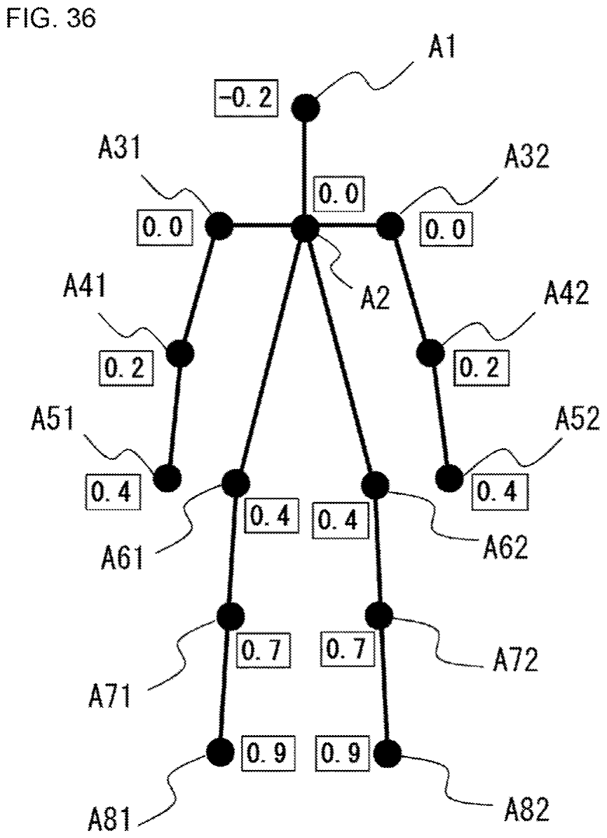

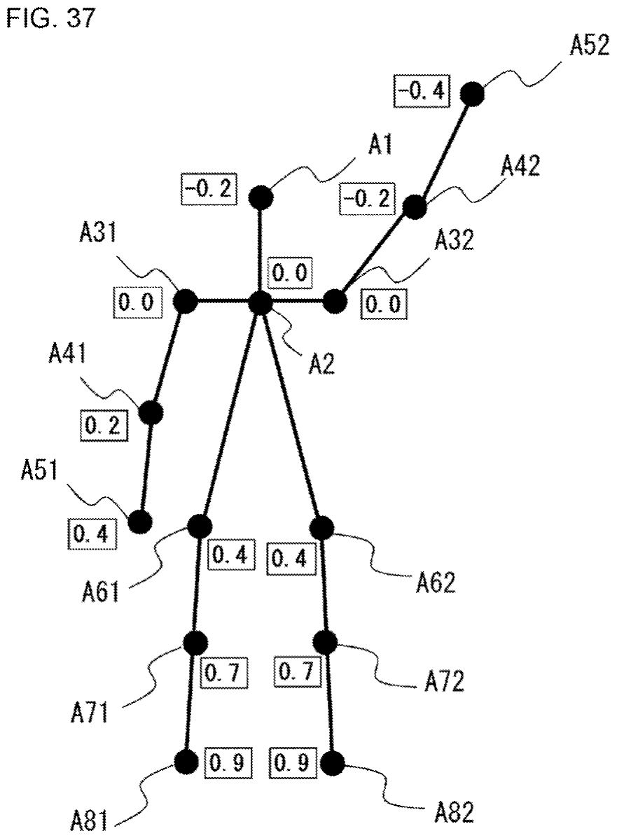

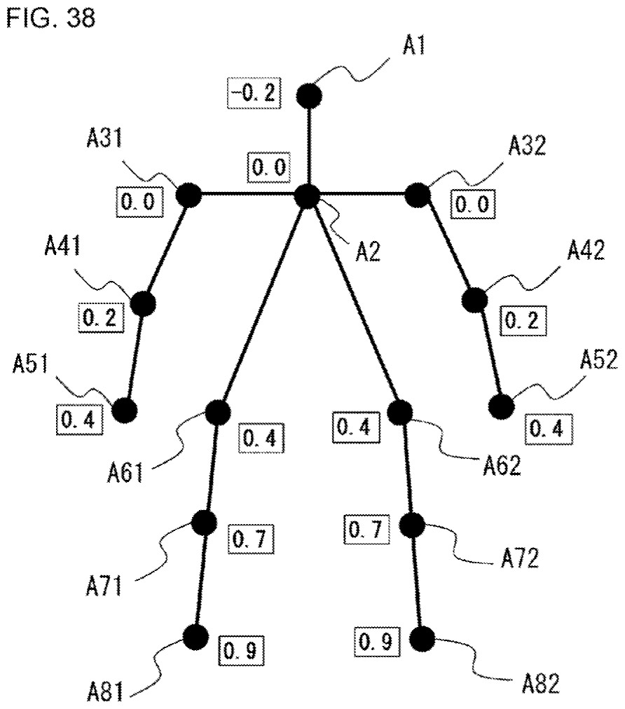

FIG. 36 illustrates an example of the feature value of each keypoint acquired by the feature value computation unit 103. In this example, since the keypoint A2 of the neck is set as the reference point, the feature value of the keypoint A2 is 0.0, and the feature values of the keypoint A31 of the right shoulder and the keypoint A32 of the left shoulder that are the same height as the neck are also 0.0. The feature value the keypoint A1 of the head higher than the neck is −0.2. The feature values of the keypoint A51 of the right hand and the keypoint A52 of the left hand that are lower than the neck are 0.4, and the feature values of the keypoint A81 of the right foot and the keypoint A82 of the left foot are 0.9. When the person raises the left hand from this state, the left hand becomes higher than the reference point as illustrated in FIG. 37, and thus the feature value of the keypoint A52 of the left hand becomes −0.4. On the other hand, since the normalization is performed by using only the coordinates of the Y-axis, as illustrated in FIG. 38, the feature value does not change even when a width of the skeletal structure changes as compared with FIG. 36. Namely, the feature value (normalized value) of the present example embodiment indicates the feature in the height direction (Y direction) of the skeletal structure (keypoint), and is not affected by the change in the lateral direction (X direction) of the skeleton structure.

As described above, in the present example embodiment, the skeletal structure of the person is detected from the two-dimensional image, and each keypoint of the skeletal structure is normalized by using the number of height pixels (height in an upright position in the two-dimensional image space) acquired from the detected skeletal structure. By using such a normalized feature value, it is possible to improve robustness in the case where classification, search, or the like is performed. Namely, since the feature value of the present example embodiment is not affected by a change in the lateral direction of the person as described above, it is highly robust to a change in the orientation of the person or the body shape of the person.

Further, in the present example embodiment, since it can be achieved by detecting the skeletal structure of a person by using a skeletal estimation technique such as OpenPose, it is not necessary to prepare learning data for learning the pose and the like of the person. Further, by normalizing the keypoints of the skeletal structure and storing them in the database, it is possible to classify and search the pose and the like of the person, and therefore, it is possible to classify and search even for an unknown pose. In addition, since a clear and easy-to-understand feature value can be acquired by normalizing the keypoints of the skeletal structure, unlike the black-box type algorithm such as machine learning, the user's satisfaction with a processing result is high.

### Third Example Embodiment

Hereinafter, a third example embodiment will be explained with reference to the drawings. In the present example embodiment, a specific example of processing of searching for a moving image including a desired scene will be explained.

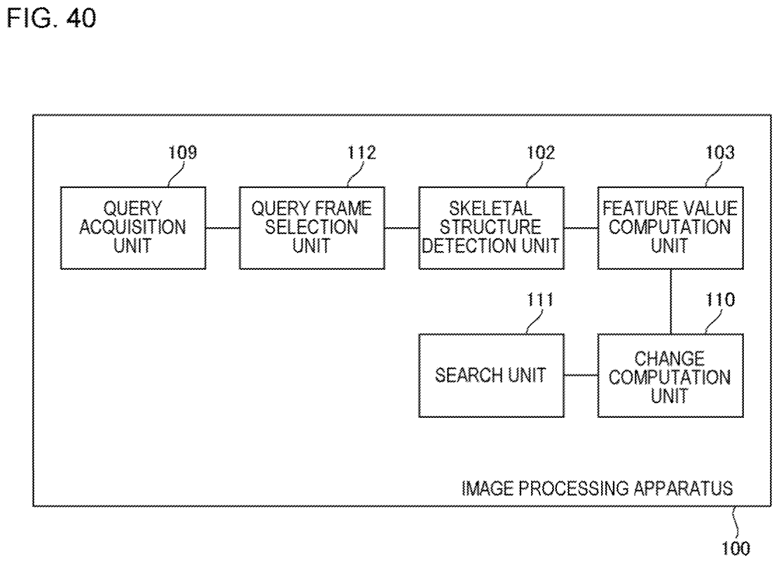

FIG. 40 illustrates an example of a functional block diagram of the image processing apparatus 100 according to the present example embodiment. As illustrated, the image processing apparatus 100 includes a query acquisition unit 109, a query frame selection unit 112, a skeletal structure detection unit 102, a feature value computation unit 103, a change computation unit 110, and a search unit 111. Note that the image processing apparatus 100 may further include other functional units explained in the first and second example embodiments. An example of a hardware configuration of the image processing apparatus 100 of the present example embodiment is the same as that of the first and second example embodiments.

The query acquisition unit 109 acquires a query moving image composed of a plurality of time-series first frame images. For example, the query acquisition unit 109 acquires a query moving image (moving image file) input/specified/selected by a user operation.

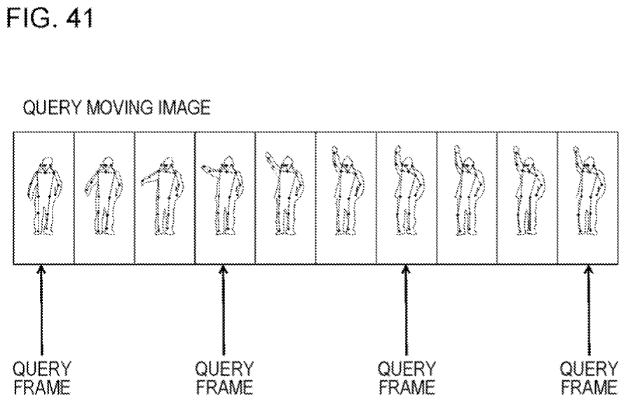

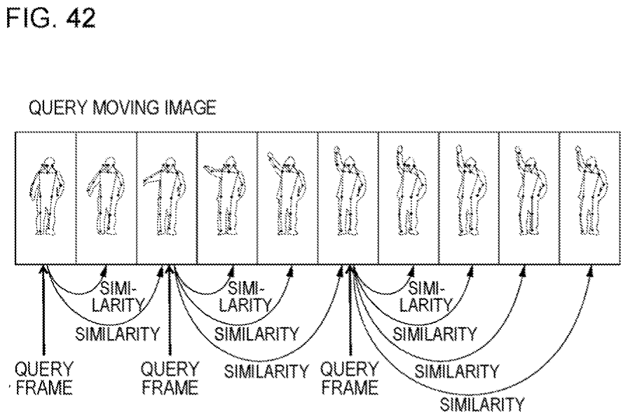

The query frame selection unit 112 selects at least a part of the plurality of first frame images as a query frame. As illustrated in FIGS. 41 and 42, the query frame selection unit 112 can intermittently select a query frame from among a plurality of time-series first frame images included in a query moving image. The number of the first frame images between the query frames may be constant or may be varied. The query frame selection unit 112 can execute any one of the following pieces of selection processing 1 to 3, for example.

### —Selection Processing 1—

In the selection processing 1, the query frame selection unit 112 selects a query frame, based on user input. Namely, the user performs an input that specifies at least a part of the plurality of first frame images as a query frame. Then, the query frame selection unit 112 selects the first frame image specified by the user as the query frame.

### —Selection Processing 2—

In the selection processing 2, the query frame selection unit 112 selects a query frame according to a predetermined rule.

Specifically, as illustrated in FIG. 41, the query frame selection unit 112 selects a plurality of query frames from among a plurality of first frame images at predetermined regular intervals. Namely, the query frame selection unit 112 selects a query frame every M frame. Examples of M include, but are not limited to, 2 or more and 10 or less. M may be predetermined or may be selectable by the user.

### —Selection Processing 3—

In the selection processing 3, the query frame selection unit 112 selects a query frame according to a predetermined rule.

Specifically, as illustrated in FIG. 42, after selecting one query frame, the query frame selection unit 112 computes a similarity between the query frame and each of the first frame images whose chronological order is the query frame and thereafter. The similarity is the same concept as in the first and second example embodiments. Then, the query frame selection unit 112 selects, as a new query frame, the first frame image whose similarity is equal to or smaller than the reference value and whose chronological order is the earliest.

Next, the query frame selection unit 112 computes the similarity between a newly selected query frame and each of the first frame images whose chronological order is the query frame and thereafter. Then, the query frame selection unit 112 selects, as a new query frame, the first frame image whose similarity is equal to or smaller than the reference value and whose chronological order is the earliest. The query frame selection unit 112 repeats the processing and selects a query frame. According to this processing, poses of persons included in the adjacent query frames differ from each other to some extent. Therefore, it is possible to select a plurality of query frames indicating a characteristic pose of the person while suppressing an increase in the query frame. The above-described reference value may be predetermined, may be selectable by the user, or may be set by other means.

Returning to FIG. 40, the skeletal structure detection unit 102 detects a keypoint of a person (an object) included in each of the plurality of first frame images. The skeletal structure detection unit 102 may set only the query frame as a target of the detection processing, or may set all the first frame images as a target of the detection processing. Since the configuration of the skeletal structure detection unit 102 is the same as that of the first and second example embodiments, detailed explanation thereof will be omitted.

The feature value computation unit 103 computes the feature value of the detected keypoint, i.e., the feature value of the detected two-dimensional skeletal structure for each first frame image. The feature value computation unit 103 may set only the query frame as the target of the computation processing, or may set all the first frame images as the target of the computation processing. Since the configuration of the feature value computation unit 103 is the same as that of the first and second example embodiments, detailed explanation thereof will be omitted.

The change computation unit 110 computes a direction of change in a feature value along a time axis of the plurality of time-series first frame images. The change computation unit 110 computes, for example, a direction of change in the feature value between adjacent query frames. The feature value is the above-described feature value computed by the feature value computation unit 103. The feature value is a height, an area, or the like of a skeletal region, and is expressed by a numerical value. The direction of change in the feature value is divided into three, for example, a “direction in which the numerical value increases”, “no change in the numerical value”, and a “direction in which the numerical value decreases”. “No change in the numerical value” may be a case where an absolute value of an amount of change in the feature value is 0, or a case where the absolute value of the amount of change in the feature value is equal to or less than a threshold value.

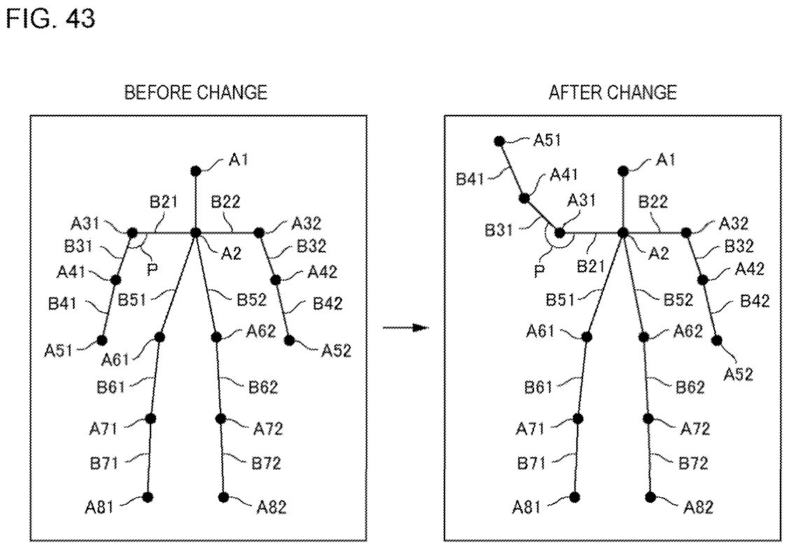

An example will be explained by using FIG. 43. Comparing images before and after change to be illustrated in the figure differs in that the right arm, which has been down before the change, is up after the change. For example, an angle P formed by a keypoint A2, a keypoint A31, and a keypoint A41 is computed as the feature value. In this case, the change computation unit 110 determines a direction in which the numerical value increases as the direction of change in the feature value along the time axis.

When three or more query frames are to be processed, the change computation unit 110 can compute time-series data indicating a time-series change in the direction of change in the feature value. The time-series data are, for example, a “direction in which the numerical value increases”→a “direction in which the numerical value increases”→a “direction in which the numerical value increases”→“no change in the numerical value”→“no change in the numerical value”→a “direction in which the numerical value increases”, and the like. When “the direction in which the numerical value increases”] is represented as “1”, for example, “no change in the numerical value” is represented as “0”, for example, and “the direction in which the numerical value decreases” is represented as “−1”, for example, the time-series data can be represented as a numerical sequence like “111001”, for example.

When only two query frames are to be processed, the change computation unit 110 can compute the direction of change in the feature value occurring between the two images.

Returning to FIG. 40, the search unit 111 searches for a moving image by using the direction of change in the feature value computed by the change computation unit 110 as a key. Specifically, the search unit 111 searches for a DB moving image matching a key from among moving images (hereinafter, referred to as DB moving images) stored in the database 201. The search unit 111 can execute, for example, any one of the following moving image search processing 1 and moving image search processing 2.

### —Moving Image Search Processing 1—

When the time-series data in the direction of change in the feature value is used as the key, the search unit 111 can search for a DB moving image in which the similarity of the time-series data is equal to or greater than the reference value. A method of computing the similarity of the time-series data is not particularly limited, and any technique can be adopted.

Note that the above-described time-series data may be generated by the same method as described above in response to each of the DB moving images stored in the database 201 in advance and stored in the database. In addition, the search unit 111 may process each of the DB moving images stored in the database 201 by the same method as described above every time the search processing is performed, and generate the above-described time-series data for each DB moving image.

—Moving Image Search Processing 2—

When the direction of change in the feature value occurring between two query frames is used as a key, the search unit 111 can search for a DB moving image indicating the direction of change in the feature value.

Note that index data in the direction of change in the feature value, which are indicated in each DB moving image, may be generated and stored in the database in advance in response to each DB moving image stored in the database 201. In addition, the search unit 111 may process each of the DB moving images stored in the database 201 by the same method as described above every time the search processing is performed, and generate index data in the direction of change in the feature value, which are indicated in each DB moving image for each DB moving image.

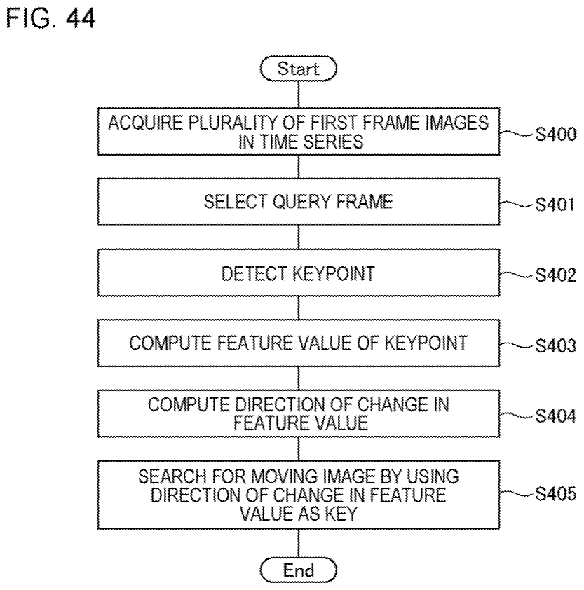

Next, an example of a flow of processing of the image processing apparatus 100 will be explained with reference to FIG. 44. Herein, the flow of the processing is intended to be explained. Since details of each processing have been described above, the explanation thereof will be omitted.

When acquiring a query moving image composed of a plurality of time-series first frame images (S400), the image processing apparatus 100 selects at least a part of the plurality of first frame images as a query frame (S401).

Next, the image processing apparatus 100 detects a keypoint of an object included in each of the plurality of first frame images (S402). Note that only the query frame selected in S401 may be a target of the processing, or all the first frame images may be the target of the processing.

Next, the image processing apparatus 100 computes the feature value of the detected keypoint for each of the plurality of first frame images (S403). Note that only the query frame selected in S401 may be the target of the processing, or all the first frame images may be the target of the processing.

Next, the image processing apparatus 100 computes a direction of change in the above-described feature value along a time axis of the plurality of time-series first frame images (S404). The image processing apparatus 100 computes a direction of change in the feature value between adjacent query frames. The direction of change is divided into three, for example, a “direction in which the numerical value increases”, “no change in the numerical value”, and a “direction in which the numerical value decreases”.

When three or more query frames are to be processed, the image processing apparatus 100 can compute time-series data indicating a time-series change in the direction of change in the feature value. When only two query frames are to be processed, the image processing apparatus 100 can compute the direction of change in the feature value occurring between the two images.

Next, the image processing apparatus 100 searches for a DB moving image by using the direction of change in the feature value computed in S404 as a key (S405). Specifically, the image processing apparatus 100 searches for a DB moving image matching a key from among the DB moving images stored in the database 201. Then, the image processing apparatus 100 outputs a search result. The output of the search results can be achieved by adopting any technique.

Herein, a modification of the present example embodiment will be explained. The image processing apparatus 100 according to the present example embodiment may be configured to adopt one or more of the following modifications 1 to 7.

### —Modification 1—

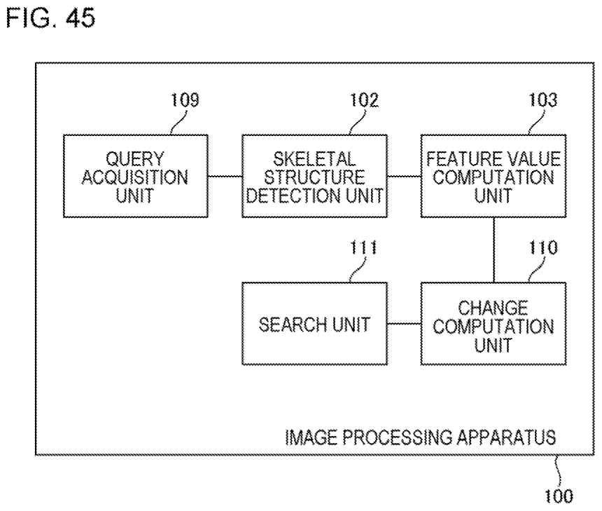

As illustrated in a functional block diagram of FIG. 45, the image processing apparatus 100 may not include the query frame selection unit 112. In this case, a change computation unit 110 can compute a direction of change in a feature value between the adjacent first frame images. When three or more first frame images are to be processed, the change computation unit 110 can compute time-series data indicating a time-series change in the direction of change in the feature value. When only the two first frame images are to be processed, the change computation unit 110 can compute the direction of change in the feature value occurring between the two images.

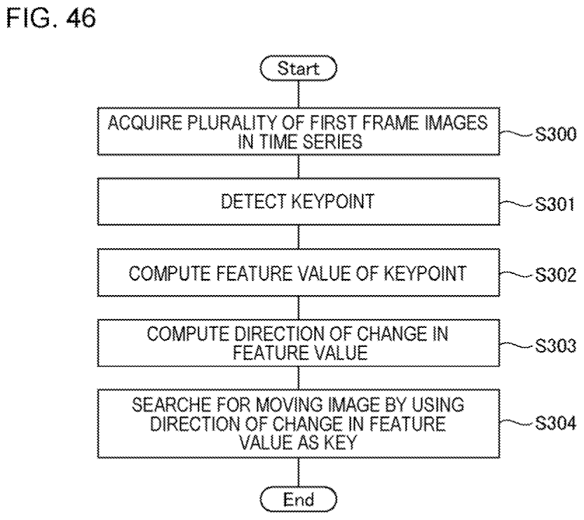

Next, an example of a flow of processing performed by the image processing apparatus 100 according to the modification will be explained with reference to FIG. 46. Herein, the flow of the processing is intended to be explained. Since details of each processing have been described above, the explanation thereof will be omitted here.

The image processing apparatus 100 acquires a query moving image composed of a plurality of time-series first frame images (S300). Next, the image processing apparatus 100 detects a keypoint of an object included in each of a plurality of first frame images (S301). Next, the image processing apparatus 100 computes a feature value of the detected keypoint for each of the plurality of first frame images (S302).

Next, the image processing apparatus 100 computes a direction of change in the above-described feature value along a time axis of the plurality of first frame images in time series (S303). Specifically, the image processing apparatus 100 computes a direction of change in the feature value between adjacent first frame images.

Next, the image processing apparatus 100 searches for a DB moving image by using the direction of change in the feature value computed in S303 as a key (S304). Specifically, the image processing apparatus 100 searches for a DB moving image matching a key from among the DB moving images stored in the database 201. Then, the image processing apparatus 100 outputs a search result. The output of the search results can be achieved by adopting any technique.

### —Modification 2—

In the above-described example embodiment, the image processing apparatus 100 detects a keypoint of a person's body, and searches for a DB moving image using the direction of the change as a key. In a modification 2, the image processing apparatus 100 can detect a keypoint of an object other than a person and search for a DB moving image using the direction of the change as a key. The object is not particularly limited, and examples thereof include an animal, a plant, a natural product, an artifact, and the like.

### —Modification 3—

The change computation unit 110 can compute a magnitude of change in the feature value in addition to the direction of change in the feature value. The change computation unit 110 can compute the magnitude of change in the feature value between adjacent query frames or between adjacent first frame images. The magnitude of change in the feature value can be represented by, for example, an absolute value of a difference between numerical values indicating the feature value. In addition, the magnitude of change in the feature value may be a value acquired by normalizing the absolute value.

When three or more images (query frames or first frame images) are to be processed, the change computation unit 110 can compute time-series data that further indicate a time-series change in the magnitude of the change in addition to the direction of change in the feature value.

When only two images (query frames or first frame images) are to be processed, the change computation unit 110 can compute the direction and magnitude of change in the feature value occurring between the two images.

The search unit 111 searches for a DB moving image by using the direction of change and the magnitude of change computed by the change computation unit 110 as keys.

When the time-series data of the direction and the magnitude of change of the feature value are used as a key, the search unit 111 can search for a DB moving image in which a similarity of the time-series data is equal to or greater than a reference value. A method of computing the similarity of the time-series data is not particularly limited, and any technique can be adopted.

When the direction and the magnitude of change in the feature value occurring between the two images (query frames or first frame images) are used as keys, the search unit 111 can search for a DB moving image indicating the direction and the magnitude of the change in the feature value.

—Modification 4—

The change computation unit 110 can compute a speed of change in a feature value, in addition to a direction of change in the feature value. This modification is effective when a query frame is selected from a first frame image at discrete intervals as illustrated in FIG. 42, and the direction of change in the feature value is computed between adjacent query frames. In this case, by referring to the speed of change in the feature value between adjacent query frames, it is possible to search for a DB moving image that is more similar.

The change computation unit 110 can compute the speed of change in the feature value between adjacent query frames. The speed can be computed by dividing the magnitude of change in the feature value by a value (the number of frames, a value converted into time based on the frame rate, or the like) indicating the magnitude of time between adjacent query frames. The magnitude of change in the feature value can be represented by, for example, an absolute value of a difference between numerical values indicating the feature value. In addition, the magnitude of change in the feature value may be a value acquired by normalizing the absolute value.

When three or more query frames are to be processed, the change computation unit 110 can compute time-series data indicating the speed of change in addition to the direction of change in the feature value.

When only two query frames are to be processed, the change computation unit 110 can compute the direction and speed of change in the feature value occurring between the two images.

The search unit 111 searches for a DB moving image by using the direction of the change and the speed of the change computed by the change computation unit 110 as keys.

When the time-series data of the direction and the speed of change of the feature value are used as a key, the search unit 111 can search for a DB moving image in which a similarity of the time-series data is equal to or greater than a reference value. A method of computing the similarity of the time-series data is not particularly limited, and any technique can be adopted.

When the direction and speed of change in the feature value occurring between the two query frames are used as keys, the search unit 111 can search for a DB moving image indicating the direction and speed of change in the feature value.

### —Modification 5—

Up to this point, the search unit 111 has searched for a DB moving image that matches the key, but may search for a DB moving image that does not match the key. Namely, the search unit 111 may search for a DB moving image whose similarity to the above-described time-series data being a key is less than the reference value. Further, the search unit 111 may search for a DB moving image that does not include a direction (which may include a size, a speed, and the like) of change in the feature value that is a key.

Further, the search unit 111 may search for a DB moving image that matches a search condition in which a plurality of keys are connected by an optional logical operator.

### —Modification 6—

The search unit 111 can search for a DB moving image by using a representative image selected from among first frame images in a query moving image as a key, in addition to a result (the direction, magnitude, speed, and the like of the change in the feature value) computed by the change computation unit 110. The representative image may be one or a plurality of images. For example, the query frame may be a representative image, a frame selected by an optional means from among the query frames may be a representative image, or a representative image may be selected from among the first frame images by other means.

The search unit 111 can search for a DB moving image in which the total similarity acquired by integrating a similarity with the query moving image, which is computed based on the representative image, and a similarity with the query moving image, which is computed based on a result (the direction, the magnitude, the speed, and the like of change in the feature value) computed by the change computation unit 110, from among the DB moving images stored in the database 201 is equal to or greater than the reference value.

Herein, a method of computing the similarity based on the representative image will be explained. The search unit 111 can compute the similarity between each of the DB moving images and the query moving image, based on the following criteria.
The similarity of the DB moving image including the frame image whose similarity with the representative image is equal to or larger than the reference value is increased.
When there are a plurality of representative images, the similarity of the DB moving image including the frame image similar to the more representative images (the similarity is equal to or greater than the reference value) is increased.
When there are a plurality of representative images, the similarity of the DB moving image is increased as a time-series order of the plurality of representative images and a time-series order of the frame images similar to each of the plurality of representative images become higher.

The similarity between the representative image and the frame image is computed based on a pose of the person included in each image. The more similar the pose, the higher the similarity between the representative image and the frame image. The search unit 111 may compute the similarity of the feature value of the skeletal structure explained in the above-described example embodiments as the similarity between the representative image and the frame image, or may compute the similarity of the pose of the person by utilizing other well-known techniques.

Next, a method of computing the similarity based on the result (the direction, magnitude, speed, and the like of the change of the feature value) computed by the change computation unit 110 will be explained. When the time-series data in the direction of change in the feature value (further, the magnitude and speed of change in the feature value may be indicated) is utilized, the similarity of the time-series data can be computed as the similarity between each of the DB moving images and the query moving image.

When the direction of change in the feature value occurring between the two query frames, the magnitude of the change, and the speed of the change are utilized, the same direction of the change as that of the query moving image is indicated, and as the magnitude of the change and the speed of the change are more similar to those indicated by the query moving image, the similarity of the DB moving image is increased.

There are various methods of integrating the similarity based on the representative image and the similarity based on the result (the direction, the magnitude, the speed, and the like of the change of the feature value) computed by the change computation unit 110. For example, each similarity may be normalized and added together. In this case, each similarity may be weighted. Namely, a value acquired by adding a similarity based on a representative image or a value acquired by multiplying a standard value thereof by a predetermined weight coefficient and a similarity based on a result (a direction, a magnitude, a speed, or the like of a change in a feature value) that is computed by the change computation unit 110 or a value acquired by multiplying the standard value by a predetermined weight coefficient may be computed as an integration result.

### —Modification 7—

As in the first and second example embodiments, the image processing apparatus 100 may constitute an image processing system 1 together with the camera 200 and the database 201.

As described above, according to the image processing apparatus 100 of the present example embodiment, the same advantageous effect as those of the first and second example embodiments can be achieved. Further, according to the image processing apparatus 100 of the present example embodiment, it is possible to search for a moving image by using a direction of change in the pose of the object included in the image, the magnitude of change, the speed of change, and the like as keys. According to the image processing apparatus 100 of the present example embodiment, it is possible to accurately search for a moving image including a desired scene.

Although the example embodiments of the present invention have been described with reference to the drawings, these are examples of the present invention, and various configurations other than the above may be adopted.

Further, in the plurality of flowcharts used in the above explanation, a plurality of steps (processing) are described in order, but the execution order of the steps to be executed in each example embodiment is not limited to the order described. In each of the example embodiments, the order of the illustrated steps can be changed within a range that does not interfere with the contents. Further, the above-described example embodiments can be combined within a range in which the contents do not conflict with each other.

Some or all of the above-described example embodiments may be described as the following supplementary notes, but are not limited thereto.

1. An image processing apparatus including:
a query acquisition unit that acquires a plurality of first frame images in time series;
a skeletal structure detection unit that detects a keypoint of an object included in each of a plurality of the first frame images;
a feature value computation unit that computes a feature value of the detected keypoint for each of the first frame images;
a change computation unit that computes a direction of change in the feature value along a time axis of a plurality of the first frame images in time series; and
a search unit that searches for a moving image by using the computed direction of change in the feature value as a key.

2. The image processing apparatus according to 1, wherein
the change computation unit further computes a magnitude of the change, and
the search unit further searches for a moving image by using the computed magnitude of the change as a key.

3. The image processing apparatus according to 1 or 2, wherein the change computation unit further computes a speed of the change, and
the search unit further searches for a moving image by using the computed speed of the change as a key.

4. The image processing apparatus according to any one of 1 to 3, wherein the search unit searches for a moving image by using a representative image among a plurality of the first frame images as a key.

5. The image processing apparatus according to 4, wherein the search unit searches for a moving image by using the feature value computed from the representative image.

6. An image processing method causing a computer to execute:
a query acquisition step of acquiring a plurality of first frame images in time series;
a skeletal structure detection step of detecting a keypoint of an object included in each of a plurality of the first frame images;
a feature value computation step of computing a feature value of the detected keypoint for each of the first frame images;
a change computation step of computing a direction of change in the feature value along a time axis of a plurality of the first frame images in time series; and
a search step of searching for a moving image by using the computed direction of change in the feature value as a key.

7. A program causing a computer to function as:
a query acquisition unit that acquires a plurality of first frame images in time series;
a skeletal structure detection unit that detects a keypoint of an object included in each of a plurality of the first frame images;
a feature value computation unit that computes a feature value of the detected keypoint for each of the first frame images;
a change computation unit that computes a direction of change in the feature value along a time axis of a plurality of the first frame images in time series; and
a search unit that searches for a moving image by using the computed direction of change in the feature value as a key.

### REFERENCE SIGNS LIST

1 Image processing system
10 Image processing apparatus
11 Skeletal detection unit
12 Feature value computation unit
13 Recognition unit
100 Image processing apparatus
101 Image acquisition unit
102 Skeletal structure detection unit
103 Feature value computation unit
104 Classification unit
105 Search unit
106 Input unit
107 Display unit
108 Height computation unit
109 Query acquisition unit
110 Change computation unit
111 Search unit
112 Query frame selection unit
200 Camera
201 Database
300, 301 Human body model
401 Two-dimensional skeletal structure

What is claimed is:

1. An image processing apparatus comprising:
at least one memory configured to store one or more instructions; and
at least one processor configured to execute the one or more instructions to:
acquire a plurality of first frame images in time series;
detect a keypoint of an object included in each of a plurality of the first frame images;
compute a feature value of the detected keypoint for each of the first frame images;
compute a direction of change in the feature value along a time axis of a plurality of the first frame images in time series; and
search for a moving image by using the computed direction of change in the feature value as a key.

2. The image processing apparatus according to claim 1, wherein
the change computation unit further computes a magnitude of the change, and
the search unit further searches for a moving image by using the computed magnitude of the change as a key.

3. The image processing apparatus according to claim 1, wherein the processor is further configured to execute the one or more instructions to
compute a speed of the change, and
search for a moving image by using the computed speed of the change as a key.

4. The image processing apparatus according to claim 1, wherein the processor is further configured to execute the one or more instructions to search for a moving image by further using a representative image among a plurality of the first frame images as a key.

5. The image processing apparatus according to claim 4, wherein the processor is further configured to execute the one or more instructions to search for a moving image by using the feature value computed from the representative image.

6. An image processing method causing a computer to execute:
acquiring a plurality of first frame images in time series;
detecting a keypoint of an object included in each of a plurality of the first frame images;
computing a feature value of the detected keypoint for each of the first frame images;
computing a direction of change in the feature value along a time axis of a plurality of the first frame images in time series; and
searching for a moving image by using the computed direction of change in the feature value as a key.

7. A non-transitory storage medium storing a program causing a computer to:
acquire a plurality of first frame images in time series;
detect a keypoint of an object included in each of a plurality of the first frame images;
compute a feature value of the detected keypoint for each of the first frame images;
compute a direction of change in the feature value along a time axis of a plurality of the first frame images in time series; and
search for a moving image by using the computed direction of change in the feature value as a key.
